(19) United States
(12) Patent Application Publication
(10) Pub. No.: US 2026/0212194 A1
(43) Pub. Date: Jul. 23, 2026

(54) HYBRID DEEP LEARNING FRAMEWORK FOR FLOOD SUSCEPTIBILITY MAPPING

(71) Applicant: King Fahd University of Petroleum and Minerals, Dhahran (SA)

(72) Inventors: Ahmed Mohammed Ahmed AL-AREEQ, Dhahran (SA); Radhwan Ali Abdulghani SALEH, Kocaeli (TR); Mustafa Mohammed Saeed GHALEB, Dhahran (SA); Sani Isah ABBA, Dhahran (SA); Zaher Mundher Yaseen YASEEN, Dhahran (SA)

(73) Assignee: King Fahd University of Petroleum and Minerals, Dhahran (SA)

(21) Appl. No.: 19/457,648

(22) Filed: Jan. 23, 2026

Related U.S. Application Data
(60) Provisional application No. 63/748,845, filed on Jan. 23, 2025.

(51) Int. Cl. G06N 3/09

(52) U.S. Cl. CPC G06N 3/09

(57) ABSTRACT

A method for training deep neural network for flood susceptibility prediction includes receiving training data including flood conditioning factor data for spatial units of geographic region together with ground truth data. The method includes inputting training data into deep neural network. The method includes generating plurality of candidate solutions, each candidate solution including parameter vector of weights and biases encoding relationships between flood conditioning factors and flood susceptibility outcomes. Further, the method includes refining each retained candidate solution by applying local search optimization process to minimize cost function computed relative to ground truth data. The method further includes selecting trained set of weights and biases for deep neural network from among refined solutions. Further, the method includes applying trained set of weights and biases to deep neural network to generate trained deep neural network configured to produce flood susceptibility probabilities for input flood conditioning factor data.

### STATEMENT OF PRIOR DISCLOSURE BY AN INVENTOR

Aspects of the present disclosure are described in A. M. Al-Areeq, R. A. A. Saleh, M. Ghaleb, S. I. Abba and Z. Mundher Yaseen, “Implication of novel hybrid machine learning model for flood subsidence susceptibility mapping: A representative case study in Saudi Arabia,” Journal of Hydrology Volume 630 (2024), 130692, which is incorporated herein by reference in its entirety.

### CROSS-REFERENCE TO RELATED APPLICATION

The present application claims benefit of priority to U.S. Provisional patent Application No. 63/748,845 having a filing date of Jan. 23, 2025 and which is incorporated herein by reference in its entirety.

### BACKGROUND

### Technical Field

The present disclosure is directed to neural networks, and more particularly to a flood susceptibility mapping using a hybrid deep learning framework such as Gbest-Guided Artificial Bee Colony With Directed Scout And Levenberg-Marquardt (Gabcds_Lm) deep learning algorithm.

### Description of Related Art

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly or impliedly admitted as prior art against the present invention.

Floods are among the most damaging natural hazards, driving loss of life, displacement, infrastructure failure, and lasting economic and environmental harm. Their frequency and severity have risen in recent decades, with flash-flood dynamics posing particular challenges for risk assessment and emergency planning. Semi-arid regions such as Saudi Arabia remain especially vulnerable. Jeddah has experienced multiple destructive flash floods (e.g., in 2009 and 2011), underscoring the need for reliable, map-scale assessments of areas prone to flooding. Flood-susceptibility mapping leverages remote sensing and GIS inputs alongside data-driven or physics-based models to identify zones with elevated likelihood of inundation for land-use planning and mitigation.

Accurately and promptly estimating flood susceptibility in urbanizing, data-sparse basins is difficult because flood occurrence depends on a complex, nonlinear interplay among topography, geology, soils, land use, drainage density, rainfall, and proximity to channels. Flash floods evolve quickly, often outpacing the temporal and spatial coverage of field observations. In semi-arid coastal settings like Jeddah, where steep upstream relief transitions to low-lying plains limited in-situ data, heterogeneous watershed characteristics, and rapid urban expansion compound modeling uncertainty. Authorities and planners therefore require methods that generalize well across space, remain robust under scarce or noisy observations, and translate multi-sensor inputs into consistent, high-resolution susceptibility products.

In conventional systems, Physically based rainfall-runoff models such as SWAT, GSSHA, MIKE simulate hydrologic processes to estimate spatiotemporal flood behavior. When well-calibrated, they can capture process linkages but typically require dense field measurements, comprehensive parameterization, and significant computational effort. Further, a Statistical and empirical approaches such as regression, frequency-ratio methods relate historical flood occurrence to conditioning factors such as slope, elevation, lithology, TWI, distance to rivers, and land use. These techniques are simpler to deploy but are often tuned to specific areas and may not transfer effectively. Machine-learning (ML) and AI models such as ANN/DNN, SVM, decision-tree ensembles, KNN, and hybrid neuro-fuzzy/MCDA variants have been widely combined with GIS and remote-sensing (e.g., DEM-derived terrain metrics, land-cover maps, rainfall) to produce susceptibility maps. Training commonly uses optimization schemes such as gradient descent, Levenberg-Marquardt (LM), or Adam. The ML/AI models can capture nonlinear relationships and achieve strong predictive accuracy in many studies. Further, Remote-sensing-driven flood inventories such as Sentinel-1 SAR change detection complement the above by delineating historical flood/no-flood locations and enabling supervised learning splits (training/validation) to assess model skill.

However, Physically based models demand extensive, high-quality field observations for parameter estimation and validation; such data are often unavailable in semi-arid and rapidly changing urban basins, limiting accuracy and scalability. Further, the regression and other conventional statistical approaches tend to be site-specific, relationships learned in one basin may degrade when applied to different geomorphologic or climatic contexts. The gradient based training of neural networks (including LM) can be sensitive to initialization, prone to local minima, and affected by overfitting when data are sparse or imbalanced, model performance may vary widely across terrains (e.g., poorer flash-flood prediction in hilly areas reported for some methods). Further, Models such as SVMs and ensemble trees often require extensive tuning, suboptimal settings can lead to biased classification, unstable convergence, or inflated false positives/negatives. Flood/no-flood datasets derived from inventories may be imbalanced or temporally limited, complicating threshold selection and leading to optimistic metrics (e.g., accuracy) unless complemented by robustness indicators such as AUC/ROC, precision, recall, and F1.

Accordingly, it is one object of the present disclosure to provide methods and systems capable of training a deep neural network for flood susceptibility prediction for flash flood prediction.

### SUMMARY

In an exemplary embodiment, a method for training a deep neural network for flood susceptibility prediction is disclosed. The method includes receiving training data including flood conditioning factor data for spatial units of a geographic region together with ground truth data representing historical flood occurrences. Further, the method includes inputting the training data into a deep neural network to provide a susceptibility probability. The method includes generating a plurality of candidate solutions, each candidate solution including a parameter vector of weights and biases encoding relationships between the flood conditioning factors and the flood susceptibility outcomes. The generating includes sampling and perturbing the parameter vectors across the solution space, and the candidate solutions are evaluated using a cost-based criterion and a selected subset of candidate solutions is retained for subsequent refinement by local optimization. Further, the method includes refining each retained candidate solution by applying a local search optimization process that iteratively adjusts the weights and biases of the deep neural network to minimize a cost function computed relative to the ground truth data, thereby producing a plurality of refined solutions. The method further includes selecting, based on the cost function, a trained set of weights and biases for the deep neural network from among the refined solutions. The method further includes applying the trained set of weights and biases to the deep neural network to generate a trained deep neural network configured to produce flood susceptibility probabilities for input flood conditioning factor data.

In another exemplary embodiment, a system for training a deep neural network for flood susceptibility prediction is disclosed. The system includes at least one processor. Further, the system includes a memory storing instructions that, when executed by the processor, cause the system to receive training data including flood conditioning factor data for spatial units of a geographic region together with ground truth data representing historical flood occurrences. The system is configured to input the training data into a deep neural network to provide a susceptibility probability. The system is configured to generate a plurality of candidate solutions, each candidate solution including a vector of weights and biases encoding relationships between the flood conditioning factors and the flood susceptibility outcomes. The generating includes sampling and perturbing the vectors across the solution space, and the candidate solutions are evaluated using a cost-based criterion and a selected subset of candidate solutions is retained for subsequent refinement by local optimization. The system may refine each retained candidate solution by applying a local search optimization process that iteratively adjusts the weights and biases of the deep neural network to minimize a cost function computed relative to the ground truth data, thereby producing a plurality of refined solutions. Further, the system may select, based on the cost function, a trained set of weights and biases for the deep neural network from among the refined solutions.

In yet another exemplary embodiment, a non-transitory computer-readable medium storing instructions that, when executed by at least one processor, cause a system to perform a method includes receiving training data including flood conditioning factor data for spatial units of a geographic region together with ground truth data representing historical flood occurrences. Further, the method includes inputting the training data into a deep neural network to provide a susceptibility probability. The method includes generating a plurality of candidate solutions, each candidate solution including a parameter vector of weights and biases encoding relationships between the flood conditioning factors and the flood susceptibility outcomes. The generating includes sampling and perturbing the parameter vectors across the solution space, and the candidate solutions are evaluated using a cost-based criterion and a selected subset of candidate solutions is retained for subsequent refinement by local optimization. Further, the method includes refining each retained candidate solution by applying a local search optimization process that iteratively adjusts the weights and biases of the deep neural network to minimize a cost function computed relative to the ground truth data, thereby producing a plurality of refined solutions. The method further includes selecting, based on the cost function, a trained set of weights and biases for the deep neural network from among the refined solutions. The method further includes applying the trained set of weights and biases to the deep neural network to generate a trained deep neural network configured to produce flood susceptibility probabilities for input flood conditioning factor data.

The foregoing general description of the illustrative embodiments and the following detailed description thereof are merely exemplary aspects of the teachings of this disclosure and are not restrictive.

### BRIEF DESCRIPTION OF THE DRAWINGS

A more complete appreciation of this disclosure and many of the attendant advantages thereof will be readily obtained as the same becomes better understood by reference to the following detailed description when considered in connection with the accompanying drawings, wherein:

FIG. 1 is an exemplary diagram of a system configured for training a deep neural network for flood susceptibility prediction, according to certain embodiments.

FIG. 2 is an exemplary pictorial representation of location and a Digital Elevation Model (DEM) map of Jeddah watershed, according to certain embodiments.

FIG. 3 is an exemplary flow diagram for training the deep neural network for flood susceptibility prediction, according to certain embodiments.

FIG. 4A is an exemplary pictorial representation of a slope flood predictor of Jeddah watershed, according to certain embodiments.

FIG. 4B is an exemplary pictorial representation of a lithological group flood predictor of Jeddah watershed, according to certain embodiments.

FIG. 4C is an exemplary pictorial representation of an altitude flood predictor of Jeddah watershed, according to certain embodiments.

FIG. 4D is an exemplary pictorial representation of a distance from river flood predictor of Jeddah watershed, according to certain embodiments.

FIG. 4E is an exemplary pictorial representation of a Hydrologic Soil Group (HSG) flood predictor of Jeddah watershed, according to certain embodiments.

FIG. 4F is an exemplary pictorial representation of a profile curvature flood predictor of Jeddah watershed, according to certain embodiments.

FIG. 4G is an exemplary pictorial representation of a land use flood predictor of Jeddah watershed, according to certain embodiments.

FIG. 4H is an exemplary pictorial representation of a Topographic Wetness Index (TWI) flood predictor of Jeddah watershed, according to certain embodiments.

FIG. 4I is an exemplary pictorial representation of a plan curvature flood predictor of Jeddah watershed, according to certain embodiments.

FIG. 4J is an exemplary pictorial representation of a rainfall flood predictor of Jeddah watershed, according to certain embodiments.

FIG. 4K is an exemplary pictorial representation of an aspect flood predictor of Jeddah watershed, according to certain embodiments.

FIG. 4L is an exemplary pictorial representation of a flow accumulation flood predictor of Jeddah watershed, according to certain embodiments.

FIG. 4M is an exemplary pictorial representation of a Topographic Position Index (TPI) flood predictor of Jeddah watershed, according to certain embodiments.

FIG. 4N is an exemplary pictorial representation of a Stream Power Index (SPI) flood predictor of Jeddah watershed, according to certain embodiments.

FIG. 4O is an exemplary pictorial representation of a Terrain Ruggedness Index (TRI) flood predictor of Jeddah watershed, according to certain embodiments.

FIG. 4P is an exemplary pictorial representation of a non-flood and flood location of Jeddah watershed, according to certain embodiments.

FIG. 5 is an exemplary flow diagram of a Levenberg-Marquardt (LM) algorithm used to train the deep neural network for flood susceptibility prediction, according to certain embodiments.

FIG. 6 is an exemplary flow diagram of an Artificial Bee Colony (ABC) and a Gbest-guided ABC algorithm used to train the deep neural network for flood susceptibility prediction, according to certain embodiments.

FIG. 7 is an exemplary flow diagram of a method for training the deep neural network for flood susceptibility prediction, according to certain embodiments.

FIG. 8 is an exemplary graphical representation of impact of the flood predictors, according to certain embodiments.

FIG. 9A is an exemplary graphical representation of a convergence rate with respect to Root Mean Square Error (RMSE) score, according to certain embodiments.

FIG. 9B is an exemplary graphical representation of a convergence rate with respect to accuracy score, according to certain embodiments.

FIG. 10 is an exemplary graphical representation of a receiver operating characteristic curve (ROC) and an area under the ROC curve (AUC) on a testing dataset, according to certain embodiments.

FIG. 11A is an exemplary graphical representation of actual and predicted values of the testing data for the LM model, according to certain embodiments.

FIG. 11B is an exemplary graphical representation of actual and predicted values of the testing data for the ABC_LM model, according to certain embodiments.

FIG. 11C is an exemplary graphical representation of actual and predicted values of the testing data for the GABC_LM model, according to certain embodiments.

FIG. 11D is an exemplary graphical representation of actual and predicted values of the testing data for the GABCds_LM model, according to certain embodiments.

FIG. 12A is an exemplary pictorial representation of a flood susceptibility mapping of the Jeddah based on the GABCds_LM model, according to certain embodiments.

FIG. 12B is an exemplary pictorial representation of the flood susceptibility mapping of the Jeddah based on the GABC model, according to certain embodiments.

FIG. 12C is an exemplary pictorial representation of the flood susceptibility mapping of the Jeddah based on the ABC model, according to certain embodiments.

FIG. 12D is an exemplary pictorial representation of the flood susceptibility mapping of the Jeddah based on the LM model, according to certain embodiments.

FIG. 13 is an exemplary flow diagram of a method for training the deep neural network for flood susceptibility prediction, according to certain embodiments.

FIG. 14 is an illustration of a non-limiting example of details of computing hardware used in the computing device, according to certain embodiments.

FIG. 15 is an exemplary schematic diagram of a data processing system used within the computing device, according to certain embodiments.

FIG. 16 is an exemplary schematic diagram of a processor used with the computing device, according to certain embodiments.

FIG. 17 is an illustration of a non-limiting example of distributed components which may share processing with a controller, according to certain embodiments.

### DETAILED DESCRIPTION

In the drawings, like reference numerals designate identical or corresponding parts throughout the several views. Further, as used herein, the words “a,” “an” and the like generally carry a meaning of “one or more,” unless stated otherwise.

Furthermore, the terms “approximately,” “approximate,” “about,” and similar terms generally refer to ranges that include the identified value within a margin of 20%, 10%, or preferably 5%, and any values therebetween.

The disclosed embodiments relate to a hybrid training framework for generating predictive flood susceptibility models. The framework employs an iterative learning process that maintains a population of candidate parameter sets, each representing a potential configuration of a predictive model. These candidate parameter sets are progressively adjusted through a combination of cooperative global search and targeted local refinement operations. By integrating broad exploration of the parameter space with precise fine-tuning, the framework trains a model that captures complex, nonlinear relationships between flood-conditioning variables and historical flood events. When the training process is completed, the resulting model can be applied to geospatial data of a target region to produce a flood susceptibility map in which each spatial unit is assigned a probability-based susceptibility level, thereby enabling data-driven identification of flood-prone zones and supporting proactive disaster management and infrastructure planning. Compared to conventional flood prediction approaches that rely solely on deterministic hydrological models or gradient-based learning methods, the disclosed hybrid training framework offers improved stability, faster convergence, and reduced likelihood of converging to sub-optimal solutions, resulting in more accurate and generalizable flood susceptibility predictions.

In one embodiment, the hybrid training framework is implemented within a deep neural network (DNN) architecture that models the relationship between flood-conditioning factors and flood susceptibility outcomes. The training of the DNN employs a hybrid search strategy that balances exploration and exploitation within the network's weight-and-bias parameter space. The exploration process broadly samples multiple regions of the parameter space to identify diverse candidate solutions (e.g., weights and biases of the DNN model) that may represent distinct hydrological behaviors within the training data. The exploitation process then refines these promising solutions through localized adjustments that minimize prediction error, thereby ensuring convergence toward a globally optimal solution rather than a sub-optimal local minimum. This hybrid balance between exploration and exploitation enables the DNN to learn subtle, nonlinear dependencies among terrain, rainfall, land use, and other flood-related variables that conventional training methods may overlook. As an example, such hybrid training may be achieved through a combination of a Gbest-guided Artificial Bee Colony with directed scout (GABCds) algorithm for the global exploration phase and a Levenberg-Marquardt (LM) optimization algorithm for the local refinement phase, although other equivalent combinations of global and local optimizers may also be employed.

The described hybrid training framework provides improved accuracy and robustness in modeling flood susceptibility compared to conventional single-method optimization techniques. By employing a global exploration phase, the algorithm captures a wider range of candidate solutions, enabling the DNN to generalize across diverse terrain types, climatic conditions, and hydrological patterns. The subsequent local refinement phase ensures rapid and stable convergence toward an optimized solution (e.g., optimized weights and biases) that minimizes prediction error without oscillation or overfitting. This dual-stage optimization mitigates the limitations of purely gradient-based methods that are prone to early convergence and instability in nonlinear data environments typical of flood modeling. As a result, the trained DNN exhibits enhanced predictive reliability even when exposed to heterogeneous, sparse, or noisy datasets, producing flood susceptibility maps that are both more accurate and transferable across geographic regions.

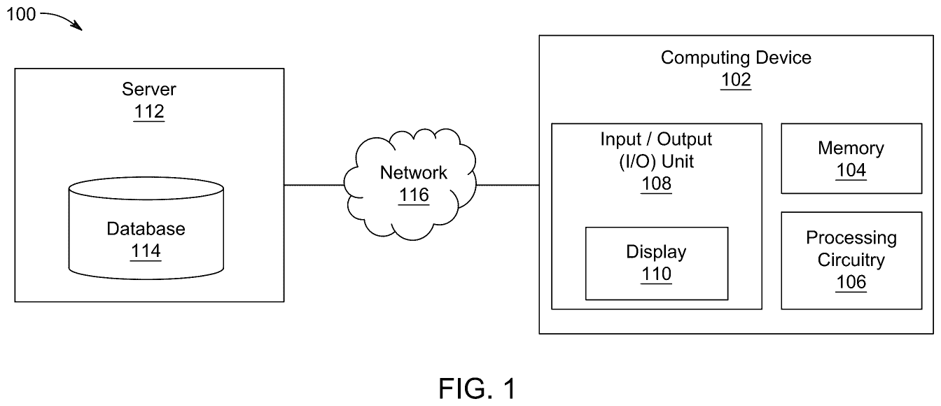

Referring now to FIG. 1, the present disclosure provides an exemplary diagram of a system 100 configured for training a deep neural network for flood susceptibility prediction, according to certain embodiments. In order to train the deep neural network for flood susceptibility prediction, the system 100 may include a computing device 102. In some embodiments, the computing device 102 may be an external system. The computing device 102 is configured to train the deep neural network for flood susceptibility prediction. Examples of the computing device 102 may include a desktop, a laptop, a tablet, a smartphone, and the like. In an embodiment, a hybrid deep-learning flood-susceptibility model employs the Deep Neural Network (DNN) whose weights are optimized using hybrid training framework such as by a Gbest-guided Artificial Bee Colony with directed scout (GABCds) combined with Levenberg-Marquardt (LM) routine. The DNN uses a compact architecture including fourteen input neurons (capturing flood-conditioning factors), two hidden layers of five neurons each, and a single-neuron output that yields a susceptibility probability for each spatial unit. Further, candidate weight vectors are explored via the GABCds metaheuristic in employed, onlooker, and scout phases. After each exploration step the LM algorithm performs fast local refinement, and improved candidates are retained while weaker ones are discarded, balancing exploration and exploitation and reducing entrapment in local minima. Trained weights are then applied to generate susceptibility probabilities that may be classified into categories to render a geospatial flood-susceptibility map. In testing, the hybrid model achieved high discriminative power (AUC≈0.95 with precision/sensitivity/specificity ≈94.9-95.6%), outperforming LM-only and other ABC variants. To predict the flood susceptibility, initially, the computing device 102 is configured to receive training data including flood conditioning factor data for spatial units of a geographic region together with ground truth data representing historical flood occurrences. In an embodiment, the computing device 102 is configured to input the training data into a deep neural network to provide a susceptibility probability.

In an embodiment, the computing device 102 is configured to generate a plurality of candidate solutions, each candidate solution including a parameter vector of weights and biases encoding relationships between the flood conditioning factors and the flood susceptibility outcomes, the computing device 102 may sample and perturb the parameter vectors across the solution space, and the candidate solutions are evaluated using a cost-based criterion and a selected subset of candidate solutions is retained for subsequent refinement by local optimization. To generate the plurality of candidate solutions, the computing device 102 may perturb each candidate solution within a neighborhood of its current parameter values to produce updated candidate solutions. Further, the computing device 102 may refine the updated candidate solution by applying the local search optimization process to adjust the weights and biases of the DNN. The computing device 102 may replace the candidate solution with the refined candidate solution if the refined candidate solution reduces the cost function, otherwise retain the candidate solution and increment a failure count associated with the candidate solution.

Further, the computing device 102 may be configured to compute a selection probability for each candidate solution based on the cost function, probabilistically selecting candidate solutions according to the selection probabilities, and perturbing each selected candidate solution to produce an updated candidate solution. The computing device 102 may refine the updated candidate solution by applying the local search optimization process to adjust the weights and biases of the deep neural network. Further, the computing device 102 may replace the selected candidate solution with the refined candidate solution if the refined candidate solution reduces the cost function.

In an embodiment, the computing device 102 may further identify a candidate solution having a failure count that exceeds a predefined threshold and generate a replacement candidate solution for the identified candidate solution. The computing device 102 may refine the replacement candidate solution by applying the local search optimization process to produce an updated candidate solution. Further, the computing device 102 may replace the identified candidate solution with the updated candidate solution if the updated candidate solution reduces the cost function. To generate the replacement candidate solution, the computing device 102 may use a directed solution relative to a best-performing candidate solution and an oppositional solution relative to an existing candidate solution. In some embodiments, each candidate solution represents a complete set of neural network parameters, including weights and biases. A directed solution is generated by adjusting the weights and biases of a candidate solution in the direction of the best-performing candidate, whereas an oppositional solution is generated by reflecting the weights and biases of a candidate solution across the limits of the search space to explore an opposite region. Each candidate solution is associated with an improvement indicator that is incremented when a candidate solution is replaced by an updated candidate solution that reduces the cost function, and the improvement indicator is used to guide generation of replacement candidate solutions.

Further, the computing device 102 is configured to refine each retained candidate solution by applying a local search optimization process that iteratively adjusts the weights and biases of the deep neural network to minimize a cost function computed relative to the ground truth data, thereby producing a plurality of refined solutions. To refine each retained candidate solution by the local search optimization process, the computing device 102 may initialize the deep neural network with the retained candidate solution and iteratively updating the weights and biases until the cost function converges below a predetermined threshold or a maximum number of iterations is reached.

In an embodiment, the computing device 102 is configured to select, based on the cost function, a trained set of weights and biases for the DNN from among the refined solutions. To select the trained set of weights and biases for the deep neural network, the computing device 102 may retain the candidate solution associated with the lowest value of the cost function from among the refined candidate solutions. Further, the computing device 102 is configured to apply the trained set of weights and biases to the DNN to generate a trained DNN model configured to produce flood susceptibility probabilities for input flood conditioning factor data.

In an embodiment, the computing device 102 is further configured to apply the trained DNN to flood conditioning factor data of a specified geographic region to generate susceptibility probability values for spatial units of the geographic region. The computing device 102 may classify the susceptibility probability values into a plurality of susceptibility categories. Further, the computing device 102 may generate a geospatial flood susceptibility map of the geographic region with zones corresponding to the susceptibility categories. In some embodiments, generating the plurality of candidate weight and bias solutions is performed using a global exploration process configured to identify diverse candidate solutions, such as a GABCds algorithm, and refining the retained candidate solutions is performed using a local optimization process configured to refine candidate solutions based on a cost function, such as an LM algorithm.

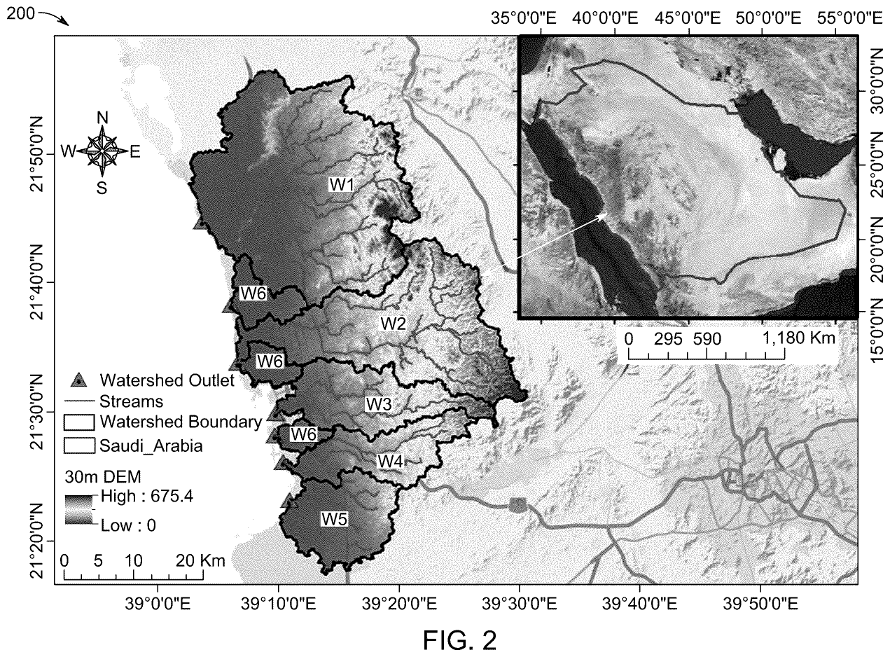

In an embodiment, the computing device 102 is configured to receive the training data from the server 112 over a network 116. Examples of the server 112 may include, but are not limited to, a desktop, a laptop, a tablet, a smartphone, and the like. Examples of the network 116 may include, but are not limited to, a Wide Area Network (WAN), a Local Area Network (LAN), a wireless network, a mobile network, a Virtual Private Network (VPN), an internet, an intranet, a public network, a private network, a packet-switched network, a circuit-switched network, an ad hoc network, an infrastructure network, a Public-Switched Telephone Network (PSTN), a cable network, a cellular network, a satellite network, a fiber optic network, or some combination thereof. The complete method of training a deep neural network for flood susceptibility prediction is further explained in detail in conjunction with FIG. 2 to FIG. 17.

The memory 104 may be a volatile memory, such as a Random-Access Memory (RAM), or a non-volatile memory such as a Read Only Memory (ROM), an Erasable Programmable Read Only Memory (EPROM), a flash memory, and the like. The memory 104 may be configured to store one or more computer-readable instructions or routines that when executed may cause the computing device 102 to train a deep neural network for flood susceptibility prediction. The memory 104 may predict the flood susceptibility with a processing circuitry 106. In other words, the processing circuitry 106 may be configured to execute the one or more computer-readable instructions stored within the memory 104 to train a deep neural network for flood susceptibility prediction. The processing circuitry 106 may be implemented as one or more microprocessors, microcomputers, microcontrollers, Digital Signal Processors (DSPs), Central Processing Units (CPUs), logic circuitries, and/or any devices that process data based on operational instructions.

In an embodiment, the computing device 102 may also include an Input/Output (I/O) unit 108. The I/O unit 108 may be used by the user to provide inputs (such as training data including flood conditioning factor data for spatial units of a geographic region together with ground truth data representing historical flood occurrences, and the like) to the computing device 102. Further, the I/O unit 108 may include a display 110. The display 110 may be used to display intermediatory results, such as residual images, high-resolution reconstructed images, color feature maps, and attention-weighted feature maps, or a final result, such as the flood susceptibility maps generated using the trained DNN model.

Referring now to FIG. 2, the present disclosure provides an exemplary pictorial representation of location and a Digital Elevation Model (DEM) map 200 of Jeddah watershed, according to certain embodiments. The DEM map 200 locates the watershed within the Kingdom of Saudi Arabia, while the main panel shows the basin draining west to the Red Sea (sea level≈0 m) from east-side mountain ranges that rise to ~675 m. The DEM 200 is derived from 30 m Advanced Spaceborne Thermal Emission and Reflection Radiometer (ASTER) data and indicates a total drainage area of about 1,821 km², contextualizing the relief that governs flash-flood response on the coastal plain.

In an embodiment, the watershed is subdivided into multiple sub-basins (labeled W1-W6) to reflect hydrologically coherent units that are primary sources of flash floods. By way of example, the northern sector includes Wadi Brayman, Wadi Daghbaj, Wadi Quraa, Wadi Um Hablain, Wadi Muraygh, and Wadi Ghaia. The middle sector includes Wadi Bani Malik and Wadi Mraikh, and the southern sector includes Wadi Methweb, Wadi Qaws, Wadi Al Khomra, Wadi Ghulail, and Asheer. Sub-basin sizes range roughly from ~24.6 km² to ~743.2 km², illustrating the heterogeneity of contributing areas represented in the DEM map 200.

In an embodiment, the cartographic elements of the DEM map 200 include stream networks symbolized by grey lines to visualize drainage paths, watershed/sub-basin boundaries shown by dark lines, outlet markers at the coastal discharge points, a color-ramped DEM legend (low elevations along the coast grading to higher elevations inland) to communicate topographic control on runoff, and a coordinate graticule, north arrow, and scale bar to support georeferencing and reproducibility for engineering analyses. The cartographic elements collectively illustrate why low-lying coastal neighborhoods on the plain are vulnerable to mountain-chain runoff during storm events. FIG. 2 serves as the base geospatial layer for subsequent feature engineering. Specifically, the 30 m DEM map 200 and the delineated hydrography support derivation of flood-conditioning factors such as elevation, slope, distance to river, plan/profile curvature, flow accumulation, Topographic Wetness Index (TWI), and related terrain indices that are used in the disclosed DNN model training and susceptibility mapping.

In an embodiment, the DEM map 200 provides a reproducible, GIS-ready foundation that locates the study area at national scale, visualizes relief and drainage controls on flooding at basin scale, and partitions the watershed into operational sub-basins used downstream (no pun) in data preparation, model calibration/validation, and presentation of flood-susceptibility results.

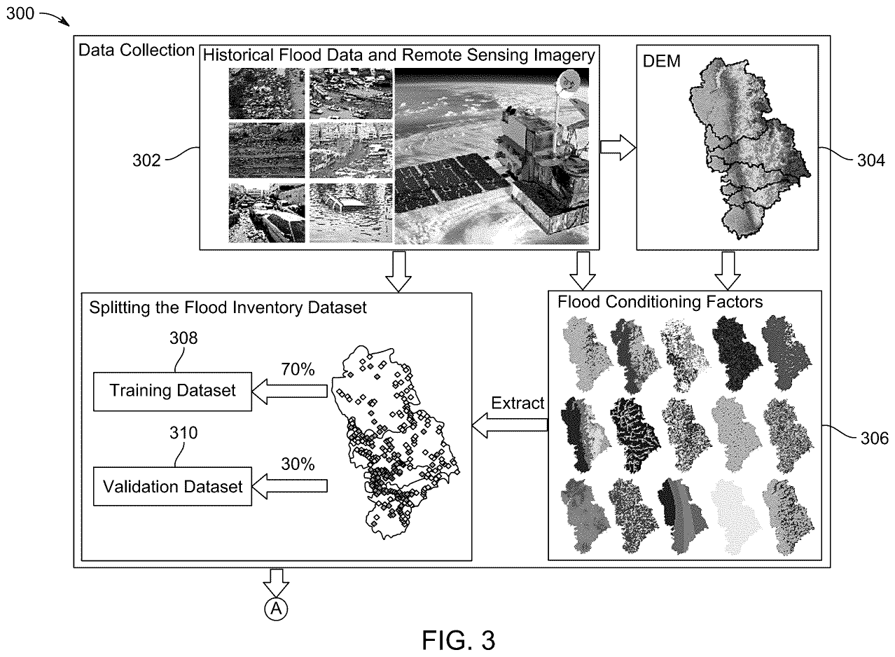

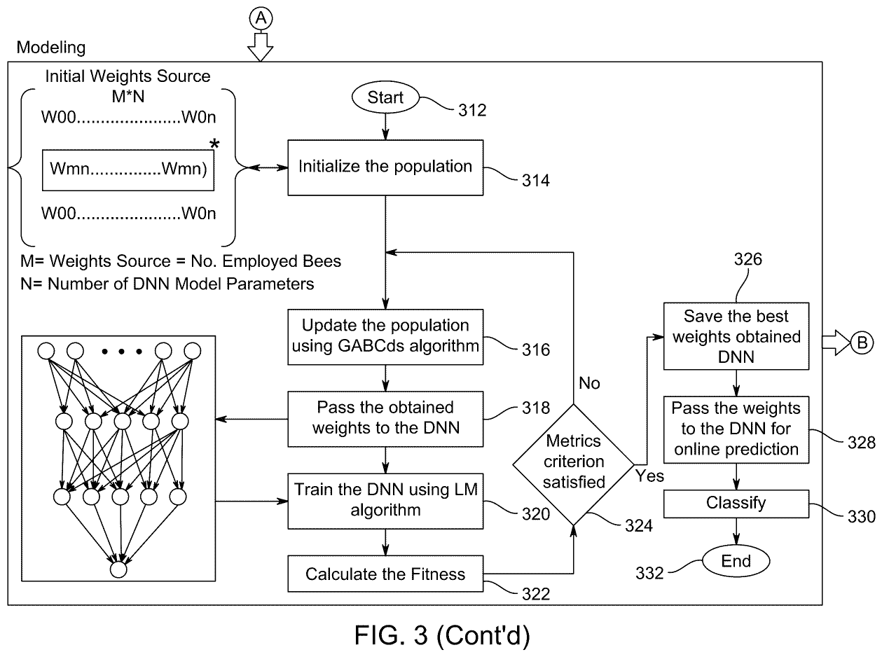

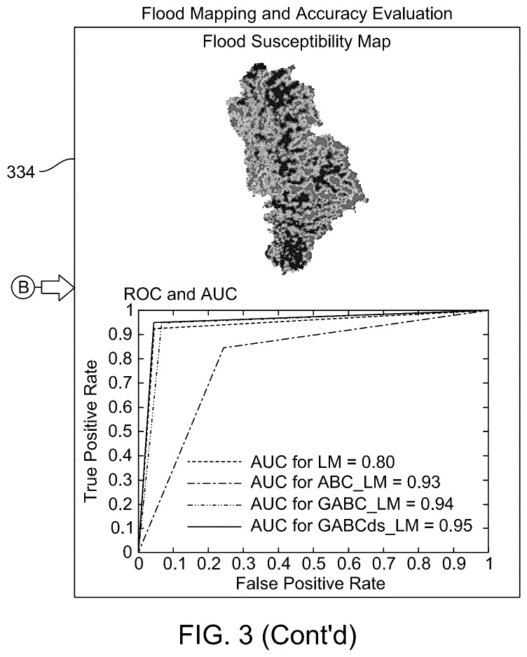

FIG. 3 is an exemplary flow diagram 300 for training the deep neural network for flood susceptibility prediction, according to certain embodiments. The flow diagram 300 begins by collecting and pre-processing heterogeneous evidence such as topography, land-cover, hydrological features, historical flood events, and subsidence records. The inputs are curated into a coherent dataset, then divided into training and validation sets, and normalized to ensure consistent scale before learning begins.

In an embodiment, at a data & feature collection and engineering stage, the system 100 fuses a flood inventory derived from historical reports and remote sensing imagery 302 with a 30 m DEM 304 to derive hydrologically meaningful predictors, such as a flood conditioning factors 306. In some embodiments, fifteen flood-conditioning factors are extracted for every sample, including slope, lithology, elevation (altitude), distance to river, soil/HSG, profile and plan curvature, aspect, flow accumulation, rainfall, land use, TRI, SPI, TWI, and TPI, etc., chosen because each modulates infiltration, runoff, or flow concentration and thus flood likelihood.

Further, a dataset preparation step formalizes learning targets by sampling equal numbers of flood and non-flood locations and then performing a 70/30 split into training dataset 308 and validation dataset 310 partitions (e.g., 99/99 for training and 42/42 for validation). The split balances learnability with an unbiased hold-out for model assessment. In some embodiments, normalization may be applied to harmonize feature ranges before optimization.

In an embodiment, a modelling stage begins, at step 312, by invoking a hybrid optimization-and-learning loop that may search the DNN weight space while progressively improving model fit across iterations. The modelling stage is designed to combine global exploration by swarm/metaheuristics with fast local convergence by a second-order solver so that near-optimal parameters may be discovered efficiently for flood-susceptibility prediction. At step 314, a population of candidate solutions (e.g., weight/bias vectors) is created. In an implementation, both biases and weights are randomly initialized within a bounded range (e.g., −2.5, 2.5) before iterative search begins.

Further, at step 316, each candidate is perturbed by a global exploration process or a metaheuristic algorithm, such as the GABCds algorithm. For example, if A, B, C and D are candidate solutions, the GABCds algorithm may perturb the solution A to generate updated solution A′.

At step 318, the updated candidate weights are passed to the DNN, and at step 320, the DNN is trained using local optimization process, such as the LM algorithm, to generate a further updated solution A″.

At step 322, the DNN's performance is evaluated to determine a fitness score of the updated solution A″ (e.g., which is measured using the cost function of the DNN). In some embodiments, improved solutions (e.g., solutions with a fitness score better than the previous solutions) are retained while the inferior ones are discarded, and the loop proceeds to the next iteration to process the candidate solutions again.

At step 324, the it is determined whether stopping conditions have been met such as reaching a maximum number of iterations or achieving target performance per the convergence/metric monitors (e.g., RMSE and accuracy curves used in the disclosure to assess stabilization). If the stopping conditions are not met, control returns to step 316 for another update-train-evaluate cycle. When the criterion is met, at step 326, the best solution (e.g., best-performing weight vector) discovered across the search is identified as the parameters (e.g., weights and biases) of the DNN to be used for prediction.

At step 328, the saved best weights are loaded into the DNN to score the full study area. For example, the flood conditioning factor data of a geographical region is input to the trained DNN, and at step 330, the DNN generates an output indicating whether the geographical region is susceptible to floods or not. For example, the DNN may generate a probability score indicating whether the geographical region is susceptible to flood or not (e.g., “0” may indicate “No Flood” and “1” may indicate “Flood”).

In some embodiments, the DNN predicts flood susceptibility values (probabilities between 0 and 1) for each spatial unit (e.g., pixel, grid cell, or polygon) of an image of a geographical region. These values are classified into categories such as very low, low, moderate, high, and very high susceptibility, or into binary classes as “flood” and “no flood”. The classified values may then be used to generate a thematic flood-susceptibility map, e.g., using GIS visualization techniques, in which different zones of a geographical map are color-coded according to their susceptibility category.

The method terminates at step 332. In summary, the flow diagram 300 formalizes a synergistic loop-global exploration by GABCds to propose diverse weight candidates, followed by local LM exploitation to fine-tune each candidate, improving convergence and generalization of the DNN for flood-susceptibility mapping.

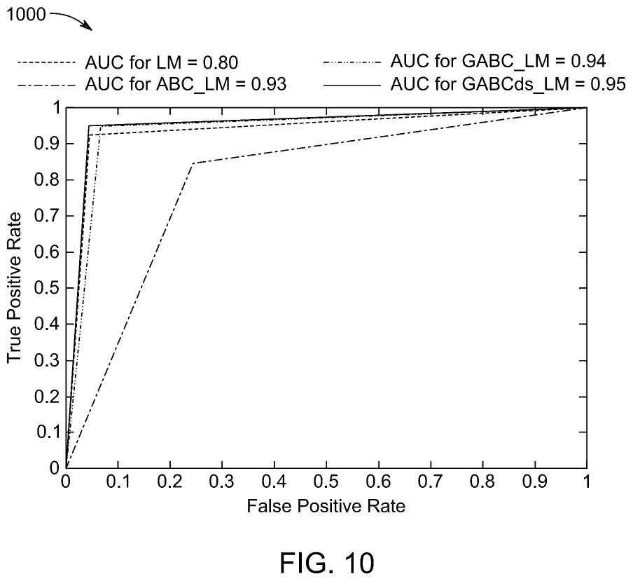

After selecting the best weights, the DNN scores every cell to produce a probability surface, which is then rendered as a thematic susceptibility map. Consistent with the cartographic protocol, probabilities are classified into five categories very low, low, moderate, high, and very high using the quantile scheme (chosen from among equal-interval, standard-deviation, natural breaks, geometric, etc., based on common practice for susceptibility mapping). The flood mapping and accuracy evaluation module 334 presents the two end-products of the workflow, the flood-susceptibility map inferred by the trained model and the Receiver-Operating-Characteristic (ROC) comparison used to quantify accuracy across competing learners. The flood mapping and accuracy evaluation module 334 visualizes the model's continuous probability output over the watershed, while the ROC plot summarizes discrimination performance as the true-positive rate is traced against the false-positive rate. In an embodiment, the ROC/AUC is expressly defined as a curve derived from true- and false-positive statistics, with AUC values ranging from 0 (worst) to 1 (best) as a measure of model agreement with reality as explained in detail in FIG. 10.

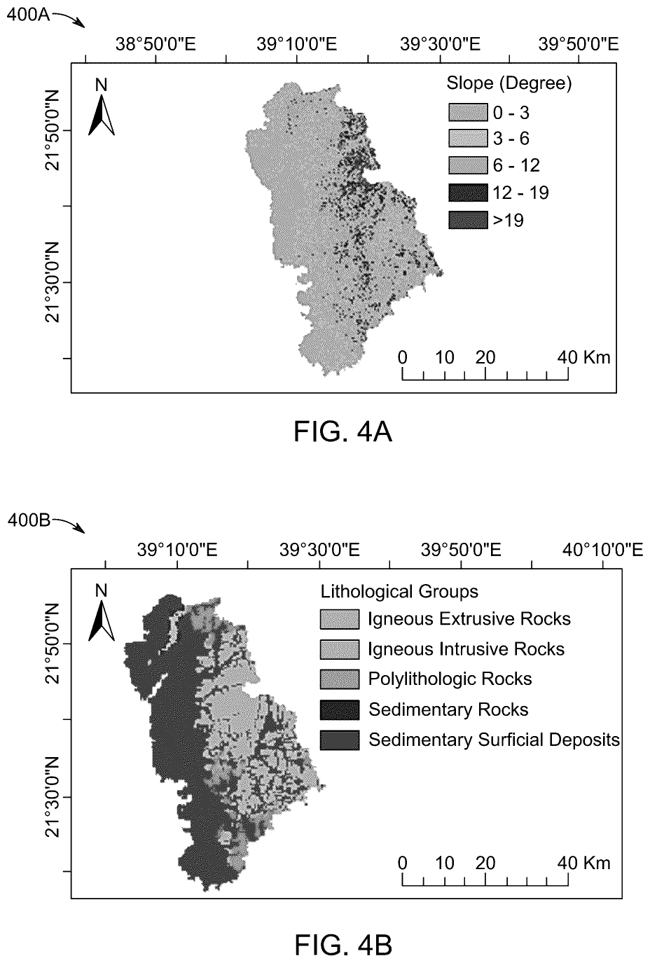

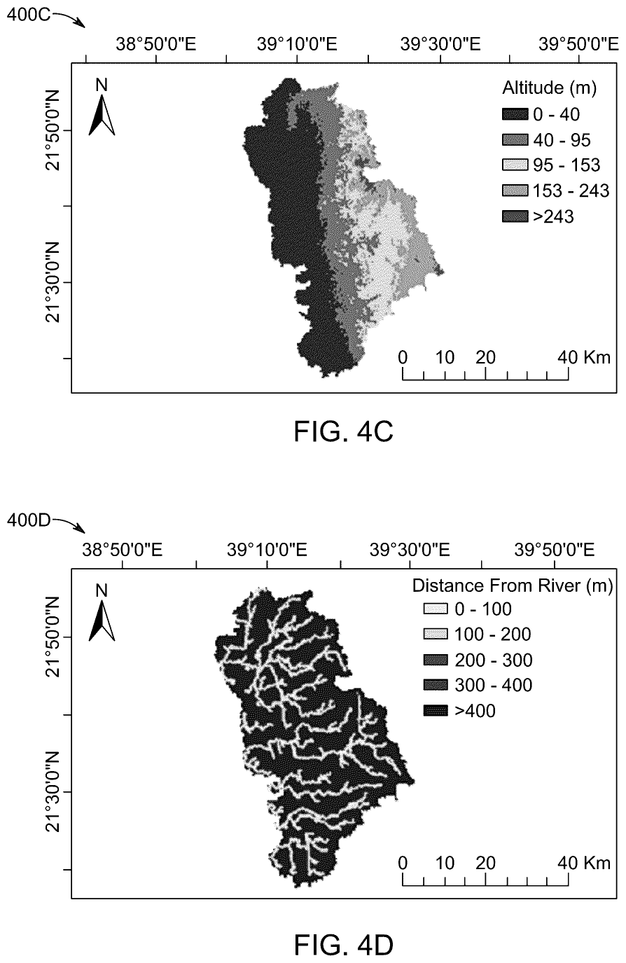

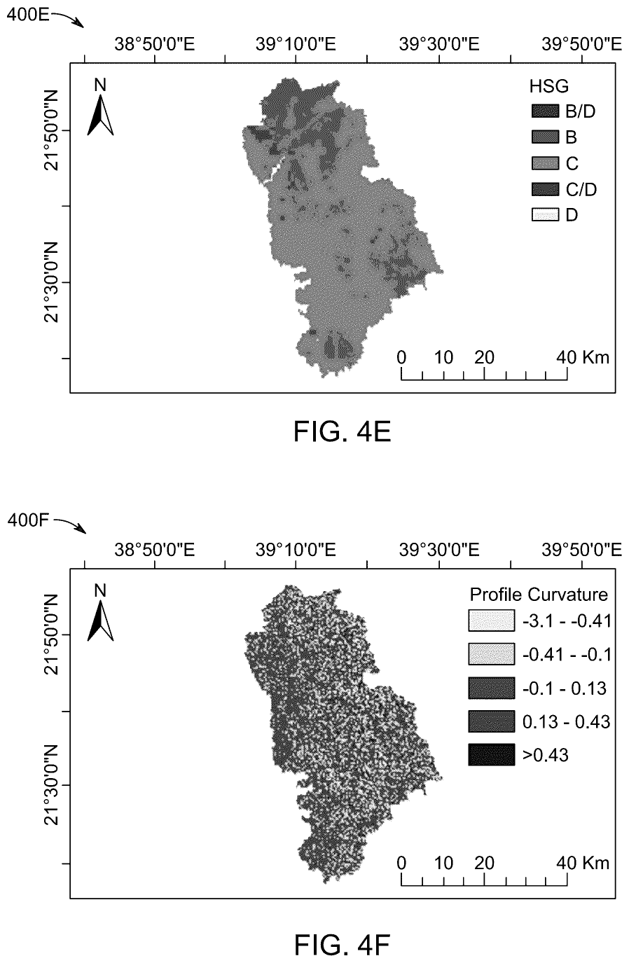

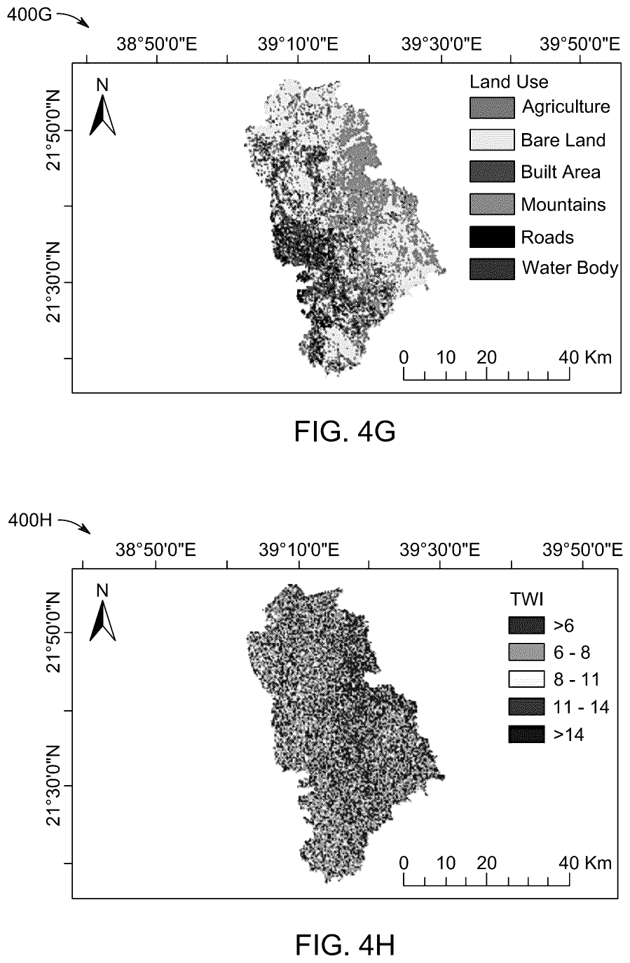

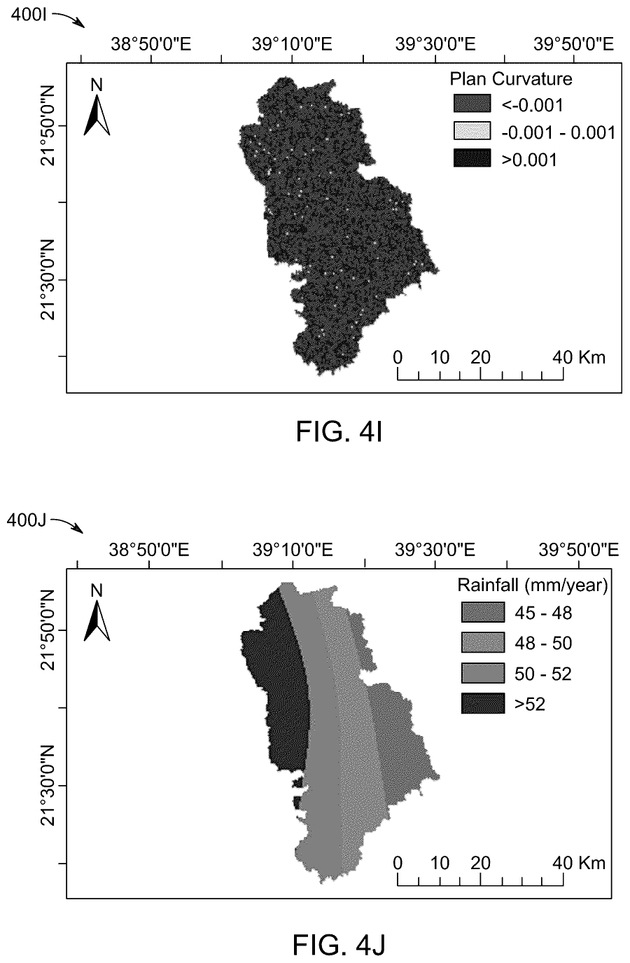

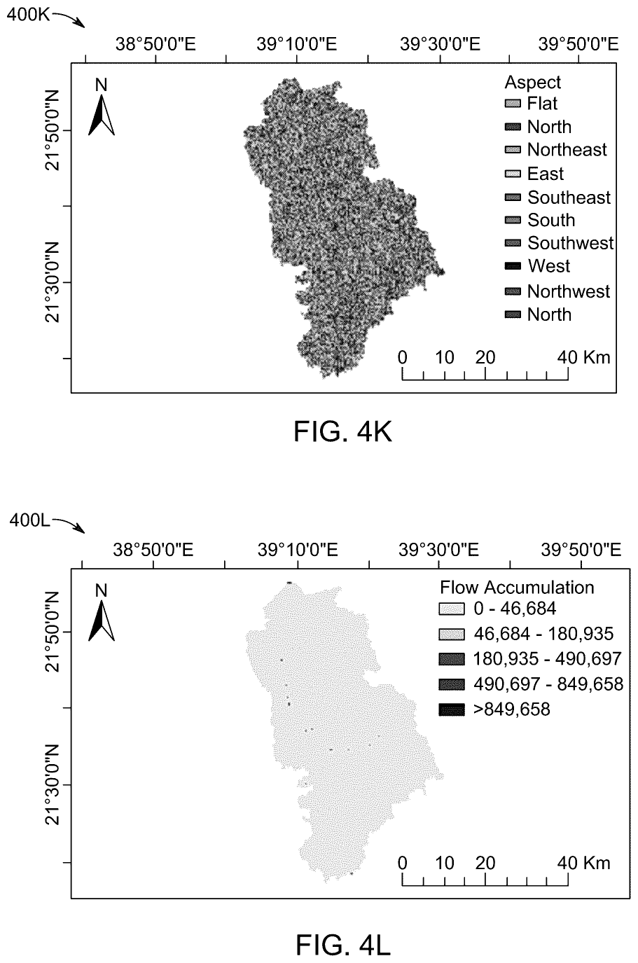

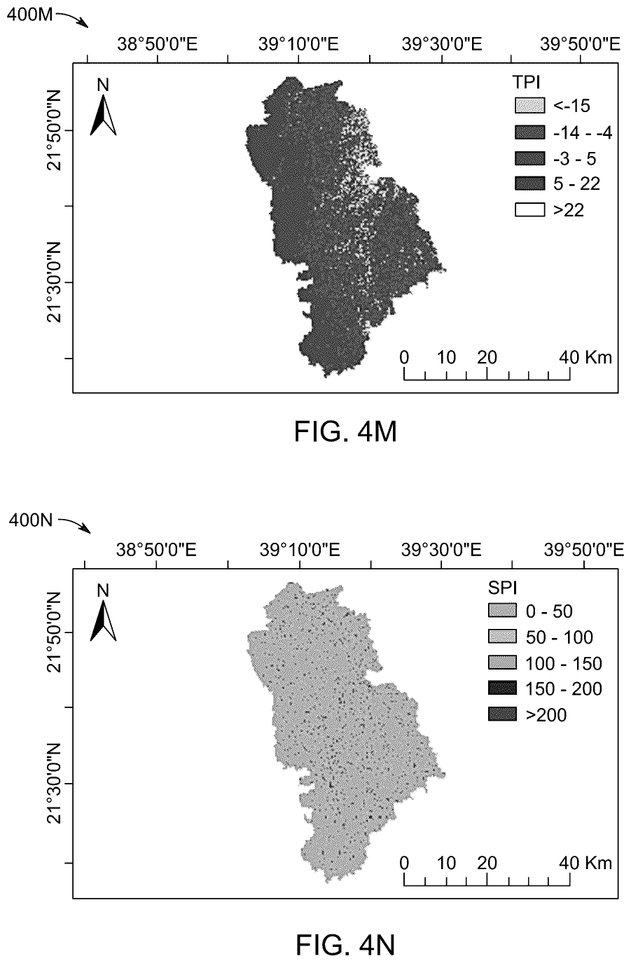

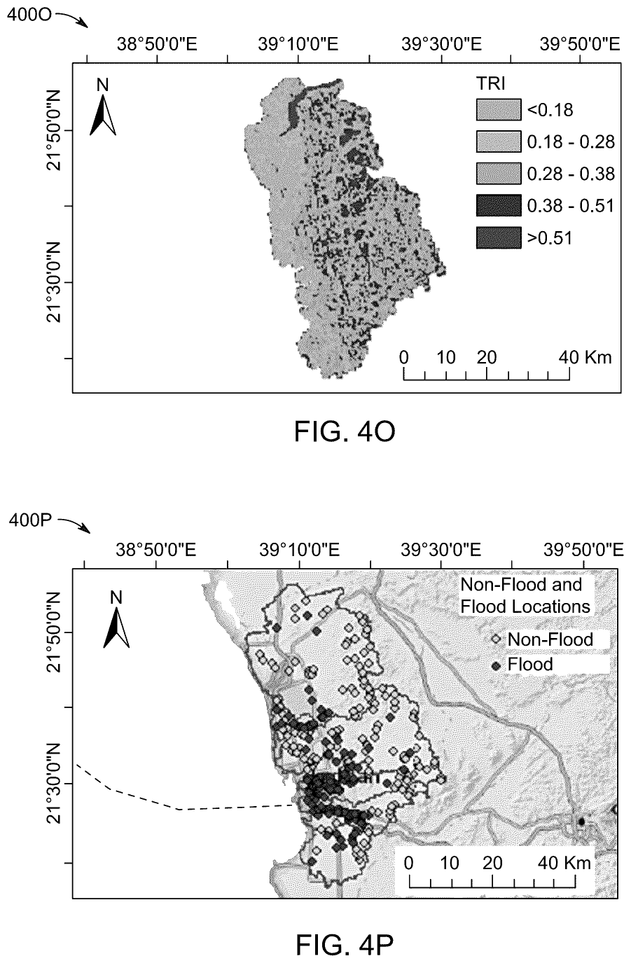

Referring now to FIG. 4A, the present disclosure provides a pictorial representation 400A of a slope flood predictor/flood conditioning factor of Jeddah watershed, according to certain embodiments. The pictorial representation 400A depicts the slope flood-conditioning factor across the Jeddah watershed. The layer is derived from the 30 m DEM prepared for the study area and rendered in degrees of surface inclination. The map frame shows a north arrow, geographic graticule, and a 0-40 km scale bar for georeferencing. Within the watershed boundary, the slope values are classified into ordered classes from nearly flat to very steep and symbolized with a sequential color ramp, enabling rapid visual interpretation of gradient contrasts that influence hydrologic response.

In an embodiment, the slope surface is computed from the DEM in a GIS environment and then masked to the watershed so that only hydrologically contributing areas are displayed. The resulting categorical layer highlights a steep eastern belt associated with the mountain front and an extensive low-gradient western plain adjacent to the Red Sea, the spatial pattern mirrors the known east-west relief and underpins the flood pathways observed historically. The operations DEM-based derivation, watershed masking, and classed rendering, produce a cartographically consistent input for subsequent learning and mapping stages.

Hydrologically, slope governs infiltration, overland-flow velocity, and flow concentration, and therefore exerts a direct control on flood generation. Flatter zones tend to retain water and develop longer ponding times, conversely, steeper hillslopes accelerate runoff and promote channelized flow and erosion that may route flood waves rapidly toward the coastal plain. For this reason, slope is included among the fifteen factors selected in the disclosure as being “strongly linked to flood catastrophes” and is treated as a first-order driver in the model's feature set.

Referring now to FIG. 4B, the present disclosure provides a pictorial representation 400B of lithological group flood predictor of Jeddah watershed, according to certain embodiments. The pictorial representation 400B depicts the lithological group flood-conditioning factor for the Jeddah watershed. The pictorial representation 400B provides a north arrow, geographic graticule, and a 0-40 km scale bar for georeferencing. Within the watershed boundary, bedrock and surficial materials are reclassified into five groups and color-coded in the legend such as, igneous extrusive rocks, igneous intrusive rocks, polylith logic rocks, sedimentary rocks, and sedimentary surficial deposits. The categorical layer visualizes the spatial heterogeneity of earth materials that modulate infiltration and runoff behavior during storm events and is one of the fifteen predictors used by the DNN model.

In an embodiment, lithology is compiled from a regional geologic map, harmonized to the project coordinate system, and masked to the watershed before grouping into the five classes shown. The resulting layer highlights an extensive belt of surficial deposits on the coastal plain and bedrock exposures toward the eastern uplands, a distribution consistent with the area's relief, where the Red Sea plain lies at ~0 m elevation and mountains rise inland to ~675 m. The preprocessing ensures that the lithology factor is cartographically consistent with the other GIS predictors derived from the 30 m DEM and used downstream in modeling. Functionally, lithology is included because different rock/soil types have different permeability and water-holding capacities, which directly influence how rainfall partitions into infiltration versus surface runoff. Permeable, coarse surficial deposits may transmit or store water until antecedent saturation is exceeded, whereas less permeable sedimentary units or massive igneous bodies may shed water rapidly, especially when coupled with steep slopes, thus changing flood likelihood and routing. By encoding lithology as a categorical predictor, the deep neural network may learn these material-specific responses alongside terrain and hydroclimatic variables.

Referring now to FIG. 4C, the present disclosure provides a pictorial representation 400C of an altitude flood predictor of Jeddah watershed, according to certain embodiments. The pictorial representation 400C depicts the altitude (elevation) flood-conditioning factor across the Jeddah watershed. The layer is rendered from the 30-m digital elevation model and is displayed in ordered classes such as, 0-40 m, 40-95 m, 95-153 m, 153-243 m, and >243 m, to visualize the transition from the low coastal plain to the higher inland uplands. Standard cartographic elements (north arrow, geographic graticule, and a 0-40 km scale bar) support georeferencing and reproducibility. The underlying relief context of the study area (Red Sea coast at ~0 m rising eastward to mountain ranges ~675 m) motivates the explicit use of altitude in flood analysis.

In an embodiment, the altitude surface is derived from the 30 m ASTER DEM, harmonized to the project spatial reference, and masked to the watershed boundary so that only contributing terrain is displayed. The resulting map reveals extensive low-lying cells along the western coastal plain and progressively higher classes toward the eastern mountain front, consistent with the region's east-west relief. The preparation produces a cartographically consistent predictor layer that may be sampled at flood/non-flood locations and fused with other GIS covariates in the learning pipeline. Functionally, altitude is one of the fifteen flood-conditioning factors selected in for training the DNN model. The elevation is emphasized because low-lying areas are more likely to experience flooding under gravity-driven flow, while higher terrain tends to drain more rapidly, especially where coupled with steep slopes and impermeable materials. Encoding altitude as a categorical/continuous predictor allows the deep neural network to learn how baseline terrain height co-acts with other physiographic and hydroclimatic variables to control observed flood occurrence.

Referring now to FIG. 4D, the present disclosure provides a pictorial representation 400D of a distance from river flood predictor of Jeddah watershed, according to certain embodiments. The pictorial representation 400D depicts the distance-from-river flood-conditioning factor for the Jeddah watershed. The pictorial representation 400D is framed with a north arrow, geographic graticule, and a 0-40 km scale bar for georeferencing. Within the watershed boundary, the stream network is shown, and the surrounding terrain is reclassified into five proximity classes such as, 0-100 m, 100-200 m, 200-300 m, 300-400 m, and >400 m, to visualize how channel adjacency varies across the basin. The layer is one of the flood predictors prepared from the 30 m DEM and related hydrography used throughout the study.

In an embodiment, the distance surface is computed in a GIS by measuring the horizontal distance from each raster cell to the mapped stream centerlines, then masking to the watershed and reclassifying the resulting continuous distance grid into the five symbolic bins shown in the legend. The workflow yields a cartographically consistent, GIS-ready factor that is spatially aligned with the other predictors derived from the same 30 m elevation framework over the ~1,821 km² Jeddah basin. Hydrologically, distance from river is a first-order control on flood hazard, inundation and overbank impacts are strongest adjacent to channels and decay with increasing setback from the river corridor. Encoding the effect as a proximity class captures the empirically observed pattern that “floods considerably influence surrounding regions and progressively lessen as one travels further away from the riverfront.”

Referring now to FIG. 4E, the present disclosure provides a pictorial representation 400E of a Hydrologic Soil Group (HSG) from river flood predictor of Jeddah watershed, according to certain embodiments. The pictorial representation 400E depicts the Hydrologic Soil Group (HSG) flood-conditioning factor across the Jeddah watershed. The pictorial representation 400E is georeferenced with a north arrow, geographic graticule, and a 0-40 km scale bar, and the watershed mask confines the display to hydrologically contributing terrain. Within the boundary, soils are symbolized by HSG classes such as, B/D, B, C, C/D, and D showing the spatial variation in runoff potential used by the model.

In an embodiment, a regional soil map is harmonized to the project coordinate system, clipped to the watershed, and reclassified into HSG categories before being rasterized to align with the other 30 m GIS predictors. The HSG scheme encodes infiltration capacity such as, Group D (and mixed C/D zones) represents low-permeability soils with high runoff potential, Groups B and C depict intermediate permeability, mixed B/D denotes areas whose runoff behavior shifts under drainage or seasonal saturation. Encoding soils in this way provides a physically meaningful surrogate for infiltration vs. overland flow, a first-order control on flood generation emphasized. Functionally, the HSG map is sampled at inventoried flood and non-flood locations and supplied to the deep neural network alongside the other fourteen conditioning factors (e.g., slope, lithology, elevation, distance from river, curvature metrics, rainfall, land use, TRI, SPI, TWI, TPI). Including soil/HSG is motivated by the documented role of soil properties in modulating runoff and flood likelihood, ensuring the model may learn how areas dominated by low-permeability soils contribute more strongly to observed flooding than areas with higher infiltration capacity.

Referring now to FIG. 4F, the present disclosure provides a pictorial representation 400F of a profile curvature from river flood predictor of Jeddah watershed, according to certain embodiments. The pictorial representation 400F depicts the profile curvature flood-conditioning factor for the Jeddah watershed. The pictorial representation 400F is georeferenced with a north arrow, geographic graticule, and a 0-40 km scale bar. Within the watershed mask, profile curvature, computed along the downslope direction from a 30 m DEM, is displayed in five ordered classes ranging from strongly concave (negative curvature) through near-planar to strongly convex (positive curvature), as shown in the legend. The factor is one of the standardized predictors prepared for the study and depicted among the “Jeddah flood predictors.”

In an embodiment, the curvature surface is derived in a GIS from the DEM, reprojected to the project coordinate system, and clipped to the watershed boundary to restrict the analysis to hydrologically contributing terrain. The continuous curvature grid is then reclassified into the legend's bins (from negative to positive values) to emphasize spatial transitions, concave hollows, planar mid-slopes, and convex shoulders/crests using a consistent symbology across all factors in the stack, producing a cartographically consistent, GIS-ready raster aligned with the other 30 m predictors used downstream by the model. Hydrologically, the profile curvature is pivotal because it governs along-slope flow acceleration/deceleration, erosion/deposition tendencies, and the likelihood of near-surface water retention. Both profile and plan curvature are significant flood-conditioning factors precisely because they summarize surface controls on infiltration, erosion, and runoff velocity, concave segments tend to slow flow and accumulate water, whereas convex segments tend to accelerate runoff and favor shedding of water.

Referring now to FIG. 4G, the present disclosure provides a pictorial representation 400G of a land use from river flood predictor of Jeddah watershed, according to certain embodiments. The pictorial representation 400G depicts the land-use/land-cover (LULC) flood-conditioning factor for the Jeddah watershed. The pictorial representation 400G is georeferenced with a north arrow, geographic graticule, and a 0-40 km scale bar and is clipped to the watershed boundary so only hydrologically contributing terrain is shown. Land-use classes are rendered categorically, Agriculture, Bare Land, Built Area, Mountains, Roads, Water Body, to visualize where impervious or sparsely vegetated surfaces coincide with drainage pathways. Land use is one of the standardized predictors enumerated for the study's “Jeddah flood predictors,” alongside slope, lithology, elevation, distance to river, HSG, curvature metrics, rainfall, aspect, flow accumulation, TWI, TRI, SPI, and TPI.

In an embodiment, land-cover data are compiled from remote-sensing sources, harmonized to the project coordinate system, rasterized to 30 m to match the DEM-derived layers, and then reclassified into the six legend classes before being masked to the watershed. The land-cover data yields a cartographically consistent, GIS-ready predictor aligned with the rest of the 30 m factor stack over the ~1,821 km² Jeddah basin, where elevations range from sea level on the Red Sea plain to ~675 m in the eastern mountains. Functionally, land use is included because its direct and indirect effects on infiltration, sediment transport, and runoff production strongly influence flood generation. Built and road surfaces typically reduce infiltration and increase rapid runoff, bare land can promote erosion and fast overland flow, agriculture may moderate or enhance runoff depending on tillage/soil cover, mountainous rocky areas often shed water quickly, and water bodies act as local sinks or flow conveyances during events.

Referring now to FIG. 4H, the present disclosure provides a pictorial representation 400H of a Topographic Wetness Index (TWI) from river flood predictor of Jeddah watershed, according to certain embodiments. The pictorial representation 400H depicts the TWI flood-conditioning factor for the Jeddah watershed. The layer is clipped to the watershed boundary and georeferenced with a north arrow, geographic graticule, and a 0-40 km scale bar. Within the boundary, TWI values derived from the 30 m DEM are rendered in ordered classes such as, >6, 6-8, 8-11, 11-14, and >14 to highlight zones with progressively greater potential for surface/near-surface water accumulation.

In an embodiment, the TWI surface is computed from DEM-based flow attributes and slope, then reprojected and masked to the watershed so that only hydrologically contributing terrain is displayed. Conceptually, the TWI is used to quantify the effect of topography on hydrology (the balance of contributing area and slope), higher TWI values flag places where water tends to accumulate and remain, and lower values indicate better-drained, shedding locations. The pictorial representation 400H visually correlates high-TWI belts with concave, lower-gradient parts of the terrain and lower-TWI belts with steeper, better-drained slopes patterns that are physically consistent with the DEM-derived flow accumulation context also used in the factor stack (accumulation of water from multiple upstream areas influences downstream flooding potential).

Referring now to FIG. 4I, the present disclosure provides a pictorial representation 400I of a plan curvature flood predictor of Jeddah watershed, according to certain embodiments. The pictorial representation 400I depicts the plan curvature flood-conditioning factor for the Jeddah watershed. The layer is derived from the 30 m DEM used throughout the study area and is clipped to the watershed boundary, cartographic elements (north arrow, geographic graticule, 0-40 km scale bar) support georeferencing. In the legend, the plan curvature is reclassified into three bins centered on zero-negative (<−0.001), near-planar (−0.001 to 0.001), and positive (>0.001)—so concave, planar, and convex planform segments can be visualized consistently across the basin.

In geospatial processing, the plan-curvature surface is computed from the DEM and expresses the lateral curvature of contour lines (flow convergence/divergence) orthogonal to slope. Negative values highlight laterally convergent zones (valley lines and hollows) that tend to concentrate overland flow, positive values denote laterally divergent zones (spurs and convex shoulders) that shed water, values near zero indicate planar sections. Encoding the sign and magnitude in discrete classes, as shown in 400I, yields a GIS-ready raster aligned with the other 30 m predictors used by the model. Hydrologically, the present disclosure explains that plan and profile curvature are significant flood-conditioning factors because they summarize surface controls on infiltration, erosion, and runoff velocity. In practice, convergent (negative) plan curvature promotes water accumulation and higher inundation likelihood, whereas divergent (positive) curvature favors dispersion and faster drainage; planar areas fall between these behaviors. By sampling the layer at inventoried flood and non-flood points and feeding it to the deep neural network alongside terrain, soil, land-use, and hydroclimatic variables, the system learns how curvature modulates flood occurrence across Jeddah's relief.

Referring now to FIG. 4J, the present disclosure provides a pictorial representation 400J of a rainfall flood predictor of Jeddah watershed, according to certain embodiments. The pictorial representation 400J depicts the rainfall flood-conditioning factor for the Jeddah watershed. The map is georeferenced (north arrow, graticule, 0-40 km scale bar) and clipped to the watershed boundary. Within the boundary, mean annual rainfall is shown in ordered classes—45-48, 48-50, 50-52, and >52 mm yr⁻¹ revealing a west-to-east gradient. The western coastal belt exhibits the highest totals, grading inland through intermediate bands to lower totals over the interior uplands. The cartography provides an immediate view of how storm water input varies spatially across the basin. The DEM/topographic context for the study area (coastal plain at ~0 m rising to ~675 m, drainage area ~1,821 km²) is documented in the disclosure and underlies the hydrologic interpretation of the layer.

In an embodiment, the rainfall surface is prepared from regional climatology/remote-sensing grids, reprojected to the project coordinate system, rasterized to 30 m to align with other predictors, and masked to the watershed. The continuous field is then reclassified into the legend's bins to standardize symbology with the rest of the factor stack and to facilitate sampling at inventory points (flood and non-flood). Functionally, rainfall is included because short-duration, high-intensity rain strongly influences flood occurrence, controlling the volume and timing of runoff delivered to channels and floodplains. Encoding rainfall as a spatial predictor allows the learning algorithm to capture how higher-input corridors (e.g., the humid coastal band) interact with terrain, soils, and land use to raise local susceptibility.

Referring now to FIG. 4K, the present disclosure provides a pictorial representation 400K of an aspect flood predictor of Jeddah watershed, according to certain embodiments. The pictorial representation 400K depicts the aspect flood-conditioning factor across the Jeddah watershed. Aspect is computed from the study's 30-m DEM and indicates the downslope facing direction of each cell. For cartographic clarity, continuous azimuths are reclassified into categorical classes (cardinal and intercardinal directions) with a separate “Flat” class where slope is near zero and aspect is undefined; the map is clipped to the watershed boundary and shown with a north arrow, graticule, and 0-40 km scale bar. Aspect is one of the fifteen standardized “Jeddah flood predictors” prepared from the DEM and companion GIS layers for model training.

Hydrologically, aspect informs potential for water accumulation or drainage by modulating solar exposure, evapotranspiration, soil-moisture retention, and vegetation cover, in arid terrain like Jeddah, slope faces that receive more insolation tend to dry and shed water faster, while shaded aspects retain moisture longer and can favor temporary ponding. Including aspect therefore captures a physiographic control that complements slope, curvature, and TWI/TPI in explaining observed flood occurrence.

Referring now to FIG. 4L, the present disclosure provides a pictorial representation 400L of a flow accumulation flood predictor of Jeddah watershed, according to certain embodiments. The pictorial representation 400L depicts the flow-accumulation flood-conditioning factor for the Jeddah watershed. The layer is clipped to the watershed boundary and georeferenced with a north arrow, geographic graticule, and a 0-40 km scale bar. Flow-accumulation values, derived from the project's 30 m DEM, are reclassified into five bins as shown in the legend (0-46,684; 46,684-180,935; 180,935-490,697; 490,697-849,658; >849,658), so that areas with little to no contributing area (pale tones) may be visually distinguished from channelized corridors and confluences with very large contributing areas (dark tones).

In an embodiment, the map is produced by standard hydrologic processing of the DEM, sinks/depressions are treated, a flow-direction grid is computed, and each cell is assigned the number of upstream cells that drain through it (flow accumulation). The continuous surface is then masked to the watershed and reclassified to the five legend classes for cartographic consistency with the other 30 m predictors (e.g., slope, curvature, TWI, etc.). Hydrologically, flow accumulation represents the build-up of water from multiple upstream areas. It is governed by topography and directly influences the volume delivered to downstream reaches, which in turn affects inundation potential in flood-prone corridors. High-accumulation belts mark concentrated drainage paths, while low values correspond to interfluves and locally shedding terrain, patterns the model leverages when learning susceptibility.

Referring now to FIG. 4M, the present disclosure provides a pictorial representation 400M of a Topographic Position Index (TPI) flood predictor of Jeddah watershed, according to certain embodiments. The pictorial representation 400M depicts the TPI flood-conditioning factor across the Jeddah watershed. The TPI is computed from the DEM by comparing each cell's elevation to the average elevation of its surrounding neighborhood. It highlights whether a location sits on a ridge/peak (positive TPI), a flat/planar surface (near-zero TPI), or in a valley/depression (negative TPI). The continuous TPI surface is clipped to the watershed and reclassified into ordered bins (as shown in the legend, e.g., <−15, −14 to −4, 3−5, 5−22, >22). The categorical rendering makes it easy to distinguish valley bottoms and concave hollows (strongly negative values) from ridges/shoulders (strongly positive values) and mid-slope flats (near zero). Because TPI is directly derived from the DEM and expresses relative topographic position. Hydrologically, the TPI is included because it helps identify ridges, peaks, flat areas, and depressions, which in turn govern where water concentrates or is shed. As noted in the disclosure, steep mountainous regions generally exhibit lower inundation potential than low-relief settings, and TPI captures the contrasts succinctly for machine-learning ingestion.

Referring now to FIG. 4N, the present disclosure provides a pictorial representation 400N of a Stream Power Index (SPI) flood predictor of Jeddah watershed, according to certain embodiments. The pictorial representation 400N depicts the SPI flood-conditioning factor across the Jeddah watershed. The pictorial representation 400N is georeferenced with a north arrow, latitude-longitude graticule, and a 0-40 km scale bar, and the display is clipped to the watershed boundary so that only hydrologically contributing terrain is shown. The SPI is a terrain index that combines upslope contributing area (as a proxy for discharge) with local slope (as a proxy for energy gradient) to indicate the potential power of flowing water at each cell. In the map, SPI values derived from the 30 m DEM are reclassified into five classes (e.g., 0-50, 50-100, 100-150, 150-200, and >200) and rendered with a sequential color ramp. Lighter tones denote low stream power on interfluves and gently sloping ground; darker tones delineate corridors where large contributing areas coincide with steeper slopes, i.e., places predisposed to high erosive power and concentrated runoff.

In an embodiment, the SPI is computed in a GIS by hydrologically conditioning the DEM (sink treatment), deriving flow direction and flow accumulation (upslope area), computing slope in radians or degrees, and forming the SPI field from those components (e.g., proportional to contributing area×tan(slope), optionally log-transformed for numeric stability). The continuous SPI grid is then projected to the project CRS, masked to the watershed, and reclassified to the legend bins used in FIG. 4N to ensure symbology consistent with the rest of the factor stack (slope, altitude, distance to river, TWI/TPI, curvatures, land use, rainfall, etc.).

Referring now to FIG. 4O, the present disclosure provides a pictorial representation 400O of a Terrain Ruggedness Index (TRI) flood predictor of Jeddah watershed, according to certain embodiments. The pictorial representation 400O depicts the TRI flood-conditioning factor for the Jeddah watershed. The TRI is computed from the DEM to quantify how rough or rugged the land surface is. The TRI expresses how irregular local relief can accelerate runoff and impede efficient drainage.

The continuous TRI grid (derived from the project's 30 m DEM) is clipped to the watershed and reclassified into five bins (legend from low to high values), producing a cartographically consistent raster aligned with the rest of the factor stack. Lower classes map the smoother coastal plain, while higher classes delineate rugged belts along mountain fronts and wadi escarpments, areas where complex micro-relief can intensify overland-flow concentration and erosion during storms. Functionally, the TRI is included because higher TRI values indicate more irregular terrain that tends to increase flood vulnerability via increased runoff and reduced drainage efficiency. Encoding TRI in discrete classes allows the learning system to capture this physiographic control in tandem with companion variables (slope, distance to river, TWI/TPI, SPI, land use, etc.). Samples from the TRI layer, taken at inventoried flood and non-flood locations, are fed to the deep neural network with the other predictors to improve spatial discrimination of susceptibility.

Referring now to FIG. 4P, the present disclosure provides a pictorial representation 400P of a non-flood and flood location of Jeddah watershed, according to certain embodiments. The pictorial representation 400P depicts the flood-inventory points used as ground truth for learning and validating the model. The flood locations and non-flood locations, all clipped to the Jeddah watershed and plotted over a basemap with coastline/roads for orientation. The points constitute the study's inventory of flood zones, a dataset of places that have experienced flooding versus those that have not, which is essential for estimating and mapping flood susceptibility.

The inventory was compiled by combining historical reports of past flood events with Sentinel-1 SAR imagery captured before and after a recent event. The SAR data were pre-processed (radiometric calibration, speckle filtering, geometric correction) and then differenced to distinguish inundated from non-inundated areas; locations were subsequently labeled “flood” or “non-flood” and recorded in GIS to form the point set visualized in 400P. For modeling, the inventory may be made balanced and split into train/validation partitions. Specifically, 141 flood and 141 non-flood locations were identified, the totals were divided 70%/30% into 99 flood+99 non-flood for training and 42 flood+42 non-flood for validation, supporting both effective learning and an unbiased hold-out evaluation.

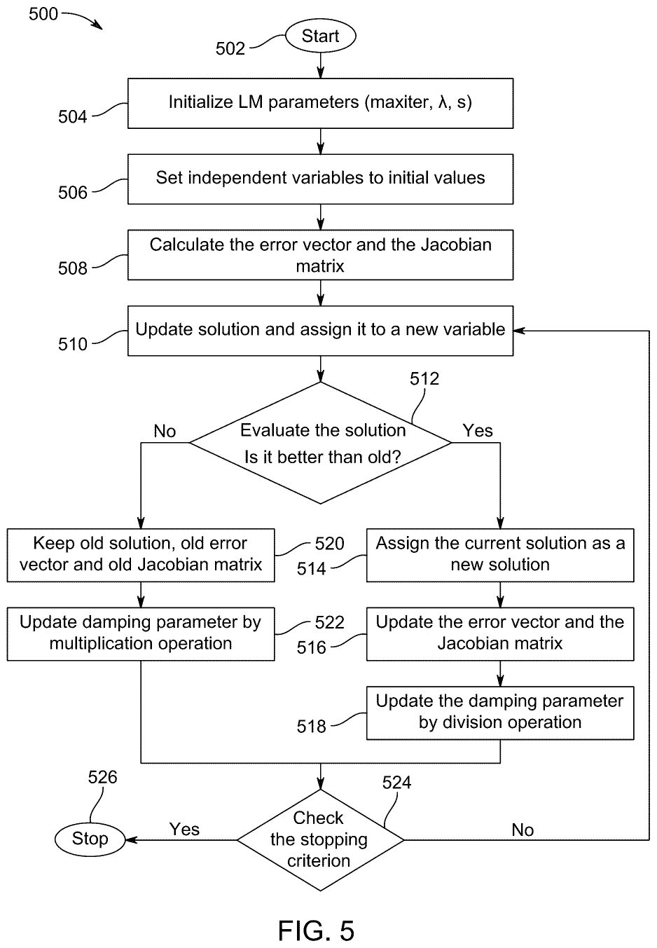

Referring now to FIG. 5, the present disclosure provides an exemplary flow diagram 500 of a Levenberg-Marquardt (LM) algorithm used to train the deep neural network for flood susceptibility prediction, according to certain embodiments. While the LM algorithm is a known DNN training technique, a brief description of the algorithm is provided below for ease of reference.

At step 502, the flow diagram 500 enters the LM inner-loop that may refine the DNN parameters (weights and biases) by solving a sequence of damped least-squares problems. In an embodiment, the LM is the second-order local optimizer used to train the DNN and is also the exploitation engine inside the hybrid pipeline.

At step 504, algorithmic hyper-parameters are initialized such as, a maximum number of iterations (maxiter), an initial damping factor (λ), and an optional step control(s). In LM, λ controls the blend between steepest-descent (very large λ) and Gauss-Newton (λ→0) behavior, proper selection and adaptation of λ is emphasized in the disclosure because it governs stability and speed.

At step 506, the vector of independent variables (the DNN's weights/biases) is initialized, either from a prior solution or from the current candidate produced by the metaheuristic outer loop (e.g., GABCds algorithm). The LM model may improve the values locally during each pass.

At step 508, with the current parameters, the network's outputs are evaluated on the training batch to form the error (residual) vector (observed minus predicted), also referred to as cost function of the DNN. The Jacobian matrix of partial derivatives of the residuals with respect to each parameter is computed for use in the LM normal equations.

At step 510, the LM model solves the damped linearized system built from the Jacobian and residuals to obtain a parameter update, applies it to the current weights, and stores the trial solution, producing the “candidate” set that may be judged in Step 512.

At step 512, the trial solution is scored using the same error metric, if the residual norm decreases (or accuracy improves), the move is accepted, otherwise it is rejected. The disclosure frames LM as a reliable but 2-sensitive second-order solver that accept/reject gate is what makes the damping schedule adaptive.

If the current solution is better that the prior solution, at step 514, the current solution is assigned as the new solution. Further, the accepted weights replace the old weights. Further, at step 516, the error vector and the Jacobian matrix are updated. With the new weights, residuals and Jacobian are recomputed in preparation for the next iteration. At step 518, the damping parameter by division is updated because the model improved, λ is reduced (division), nudging LM toward Gauss-Newton behavior for faster convergence on a well-behaved surface.

If the current solution is not better that the prior solution, at step 520, old solution, old error vector, and old Jacobian matrix are kept. The current solution is discarded, and the previous weights are retained. Further, at step 522, the damping parameter are updated by multiplication because the trial step failed, A is increased (multiplication), shifting LM toward a safer steepest-descent regime to take a smaller, more conservative step on the next iteration.

At step 524, the flow diagram 500 terminates when any stopping condition is met e.g., the maximum number of iterations (maxiter), sufficiently small change in error/parameters, or meeting the study's convergence targets used in the training workflow. If not satisfied, control returns to Step 510 for another update-evaluate cycle.

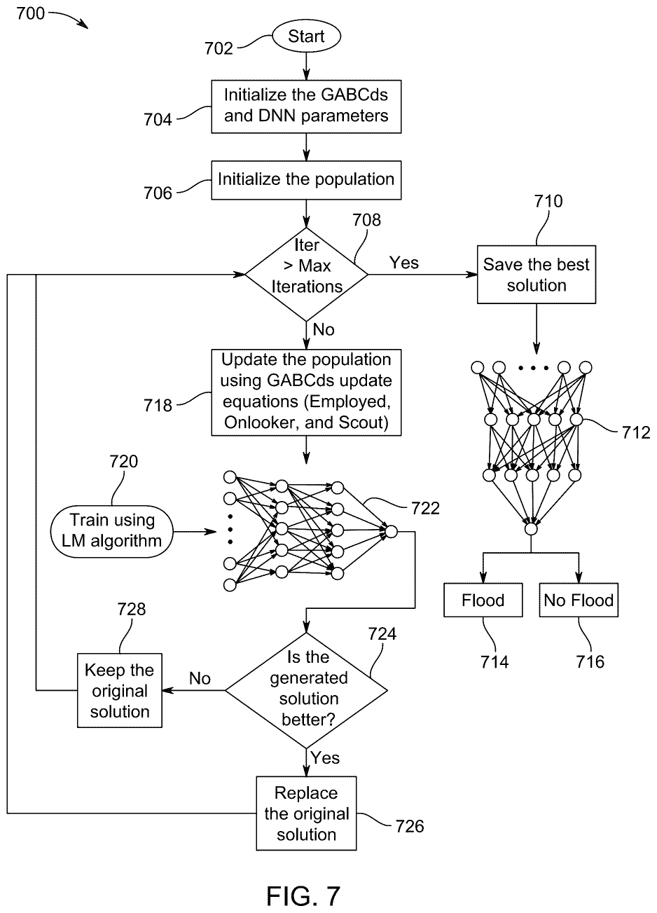

At step 526, the LM model exits, and the final weights are handed back to the workflow (e.g., to the hybrid training framework discussed at least with reference to FIG. 7 and algorithm pseudocode below). In the hybrid embodiments, the LM-refined weights are compared against the metaheuristic's incumbent solutions, and better solutions are saved and inferior ones discarded, yielding the best set used later for mapping in the inference stage of the DNN.

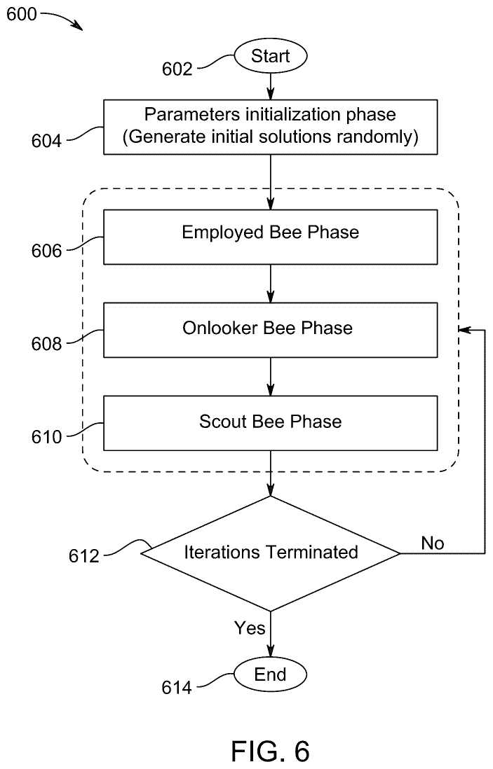

Referring now to FIG. 6, the present disclosure provides an exemplary flow diagram 600 of an Artificial Bee Colony (ABC) and a Gbest-guided ABC algorithm, according to certain embodiments.

At step 602, the flow diagram 600 enters the swarm-optimization loop that treats each candidate set of DNN weights/biases as a “food source,” whose nectar equals model quality (fitness). The ABC mimics bee foraging with three phases, employed, onlooker, and scout and GABC adds attraction toward the global-best solution to improve exploitation.

At step 604, the parameters are initialized configuring the population (e.g., population size, Food Number=half of the population, limit for abandonment, maximum iterations). The initial weight vectors are randomly created within bounds using an initialization rule. In an embodiment, the DNN has 14 inputs, two hidden layers (5 neurons each), and one output; the solution dimension is therefore 111 parameters.

At step 606, each employed bee perturbs its current solution (e.g., weights and biases) to generate a neighbor. The ABC update is neighborhood exploration, GABC adds a gbest pull, so new solutions gravitate toward the best-known vector. In some embodiments, the GABC may be customized with LM training, creating the hybrid training framework, and the resulting weights from the employed bee phase are then used to initialize LM, which quickly refines them on the training set (e.g., as described at least with reference to FIG. 5 above). The refined fitness is compared against the original and greedy selection keeps the better one. A success indicator is incremented and the failure counter reset on improvement; otherwise only the failure counter increases.

At step 608, a normalized selection probability is computed for each food source from its fitness. Onlookers sample sources with roulette-wheel selection, apply the same GABC update, pass the candidate to LM for local refinement, and again use greedy replacement with the same indicator/failure bookkeeping.

At step 610, if a solution's failure count exceeds a threshold limit, it is abandoned and replaced. In an embodiment, the GABC with directed scout (GABCds), replacement is directed instead of purely random, builds a directed global solution near fertile space between the current global-best and the most promising (highest-indicator) source.

At step 612, the stopping condition (e.g., reaching the set maximum iterations or achieving target fitness) is checked. If the stopping condition is not met, the control loops back to the employed/onlooker/scout cycle. If the stopping condition is met, the method terminates at step 614.

At step 614, the best weight vector found across the cycle is returned.

The hybrid training framework employs an optimization framework that integrates a population-based global search with a local refinement process to train the DNN for flood susceptibility prediction. A population of candidate solutions, each representing a complete combination of network weights and biases, is first initialized within defined numerical bounds. The hybrid training framework iteratively updates and refines these candidate sets through a sequence of three cooperative phases—an employed bee phase, an onlooker bee phase, and a scout bee phase—that collectively balance global exploration and local exploitation within the solution space. In some embodiments, the global exploration is performed using a GABCds algorithm, which distributes and updates candidate solutions across multiple regions of the solution space to maintain diversity and avoid premature convergence. Each candidate solution generated during these search phases is then refined through LM optimization process, which locally adjusts the weights and biases to minimize a cost function computed against ground-truth flood data. The combined operation of these two algorithms allows the system to identify promising regions of the solution space through exploration and to converge rapidly toward high-accuracy solutions through exploitation. Throughout the iterative process, each candidate solution maintains improvement and failure counters that govern whether it continues to evolve or is replaced, enabling adaptive learning behavior across the three phases. This hybrid strategy provides a continuous interplay between population-based search and localized fine-tuning, producing a robustly trained DNN capable of modeling complex flood susceptibility relationships.

The following paragraphs describe additional details of each of the three phases.

The candidate solutions are initialized is first initialized within defined numerical bounds, e.g., using Eq. (1) below. In the employed bee phase, every candidate solution in the defined set of “food sources” (e.g., half of the population) is independently processed once per iteration. For each stored candidate, a perturbed version of its weight-and-bias vector is generated using a neighborhood update equation (e.g., Eq. 2). The perturbed vector is applied as the initial condition for the LM algorithm, which locally refines the weights to minimize the cost function. The refined candidate is then compared with the original stored candidate. If the refined candidate yields a lower cost value, it replaces the stored candidate, its improvement counter is incremented, and its failure counter is reset. Otherwise, the stored candidate is retained and its failure counter incremented. This phase ensures that every candidate has one deterministic opportunity for local improvement in each cycle.

The onlooker bee phase performs probabilistic selection and further refinement of the candidates. Each candidate's fitness is first evaluated based on the cost function (e.g., using Eq. 3), and nectar levels of the food sources, that is, a probability of the candidate solution is computed proportionally to its fitness (e.g., using Eq. 4). The algorithm then performs a series of selection events equal in number to the population size. In each event, a candidate is chosen according to its selection probability, perturbed, and refined through the LM algorithm. The refined version is compared with the candidate presently stored in that population slot, and replacement occurs only if the refined solution improves the cost function. Because the selection is stochastic, better-performing candidates are more likely to be refined multiple times, while weaker candidates may be skipped, allowing adaptive intensification around high-fitness regions of the parameter space.

The scout bee phase introduces new diversity into the population by replacing candidates that have repeatedly failed to improve. That is, it identifies the solution that has the highest potential for failure. Each stored candidate maintains a failure counter that increments after every unsuccessful refinement. When this counter exceeds a predefined limit, the candidate is designated as exhausted and is replaced with a newly generated candidate. The new candidate may be derived using a directed update influenced by the current best solution (e.g., using Eq. 5) or by an oppositional update that mirrors an existing candidate across the parameter bounds (e.g., using Eq. 6). Each replacement candidate is locally refined through the LM process, and the better of the newly generated options is retained. This phase prevents stagnation of the population and maintains exploration of the global solution space.

The above three phases are executed for a predefined number of iterations or until a specific accuracy (e.g., cost function value) is obtained. At the end of the prescribed number of iterations, each stored candidate represents a distinct, locally optimized weight-and-bias configuration of the DNN. The algorithm evaluates all remaining candidates using the cost function and selects the configuration that exhibits the lowest cost value as the final trained network. This selected configuration constitutes the optimized DNN model parameters that provide the most accurate mapping between the flood conditioning factors and the flood susceptibility outcomes. A DNN model is set with these optimized parameters and is used in the inference stage for prediction of flood susceptibility of any geographical region based on it flood predictors/flood conditioning factors.

Referring now to FIG. 7, the present disclosure provides an exemplary flow diagram 700 of a method for training the deep neural network for flood susceptibility prediction using a hybrid training framework, according to certain embodiments.

At step 702, the training routine enters the hybrid optimization loop. Each candidate “solution” in the loop is a full vector of DNN parameters (weights and biases). In an embodiment, the network uses 14 inputs, 5 hidden, 5 hidden, 1 output, i.e., 111 parameters per solution. The ABC population size, abandonment limit and iteration budget are initialized.

At step 704, global (swarm) settings are set such as Population Size=30, Limit=100, Food Number (FN/SN)=population/2, Max Iterations=300—and bounds for each weight/bias (e.g., −2.5 to +2.5) are defined.

At step 706, an initial pool of candidate weight vectors is randomly sampled within bounds using the initialization rule (e.g., Eq. 1). Each vector encodes a full set of DNN weights/biases.

At step 708, at the start of each cycle the method checks whether the iteration budget has been exhausted. If yes, the loop terminates, and the best solution found so far is retained. If no, the optimization proceeds with the three GABCds phases at step 718.

At step 710, across the population and iterations, the algorithm maintains the global best (lowest cost/highest fitness) solution. When the loop ends at 708, this best set of weights is saved for inference, i.e., a DNN model is set with these weights for generating the flood-susceptibility map for any given region and used in the downstream accuracy evaluation (ROC/AUC).

At step 712, the DNN outputs a probability that each sample is “Flood” 714 or “No Flood” 716.

If the iteration budget has not been exhausted, at step 718, in a first phase (employee bee phase), each candidate is perturbed to generate a neighbor using the Gbest-guided update (adds an attraction term toward the current global best to improve exploitation). A greedy decision keeps whichever version scores better, as described earlier. In a second phase (onlooker phase), candidates are selected with probability proportional to fitness and perturbed again with the same Gbest-guided rule, the greedy keeper rule is reapplied to keep, whichever version scores better, as described earlier. Further, in a third phase (scout phase) any exhausted solution (failure count>limit) is replaced not by a random point but by a directed proposal near a fertile region defined by the current global best and the most promising source. Its generalized oppositional counterpart is also tried, and the better of the two replaces the exhausted solution.

At step 720, every newly generated weight vector is used to initialize the DNN, which is then locally optimized by LM on the training subset. The LM's damped Gauss-Newton steps rapidly reduce the cost near each candidate, yielding a refined solution for evaluation.

At step 722, the refined DNN is evaluated against the objective/fitness (derived from classification error using ground truth data). The DNN outputs a probability that each sample is “Flood” or “No Flood.”

At step 724, if the LM-refined candidate improves the fitness, it replaces its parent. The solution's “indicator” (improvement counter) is incremented and its failure counter reset. If not, the original is kept and the failure counter increases. The book-keeping signals guide the directed-scout logic later.

At step 726, the population member is overwritten by the improved weights, ensuring monotonic retention of the best-seen version of that candidate.

When the candidate does not improve, at step 728, the current solution is kept intact and its failure count is recorded, making it eligible for directed-scout replacement if it continues to stagnate. In some embodiments, the steps 720-726 are executed for each iteration in each phase, and each phase is executed for a number of iterations (e.g., as many as the number of food sources FN or SN).

In an embodiment, the parameters of the GABCds algorithm have been chosen as follows: Population Size=30, Limit=100, Food Number (FN)=half of the population, and the Maximum Iterations=300. After that, the population of food sources (FN) was initialized randomly using equation 1.

$${x}_{i}^{j} = {x}_{min}^{j} + rand ( 0 , 1 ) ( {x}_{max}^{j} - {x}_{min}^{j} ) where {x}_{min}^{j} \qquad ( 1 )$$

is the lower bound and xₘₐₓ^{j} is the upper bound of the jth food source (solution). In the next step, the Employed Bee Phase starts, in which each solution is updated using equation 2. Then, each updated solution is used as an initial weight for the LM algorithm. Thereafter, the DNN is trained using LM algorithm and tested using equation 3. If the weight vector obtained from the LM is better than the original solution, it is altered instead of the original solution, its indicator parameter will rise by one, and its failure value will be reset to zero. Otherwise, the original solution is kept unchanged, and its failure value will rise by one.

$${v}_{i}^{j} = {x}_{i}^{j} + rand ( 0 , 1 ) ( {x}_{i}^{j} - {x}_{k}^{j} ) + rand ( 0 , C ) ( {x}_{gbest}^{j} - {x}_{i}^{j} ) \qquad ( 2 )$$

Where j∈[2, D] and k∈[2, FN] are randomly selected indices, D is the dimension of the solution (D=14*5+5+5*5+5+5+1=111), and i is not equal to k.

$$Fit ( i ) = \{ \begin{matrix}\frac{1}{1 + f ( i )} , & f ( i ) < 0 \\ 1 + \vert f ( i ) \vert , & f ( i ) \geq 0\end{matrix} \qquad ( 3 )$$

where f(i) is the accuracy obtained from solution i. Further, next step is called the onlooker bee phase, where each observer bee will choose a food source based on the quality data derived from the food sources supplied by the employed bees. The likelihood of the source's quality is determined by equation 4.

$${P}_{i} = \frac{Fit ( i )}{{\sum }_{i = 1}^{N} Fit ( i )} \qquad ( 4 )$$

The chosen food source (solution) may be used as an initial weight for the LM algorithm. After that, the DNN is trained using the LM algorithm and tested using equation 3. If the weight vector obtained from the LM is better than the original solution, it is altered instead of the original solution, its indicator parameter will rise by one, and its failure value may be reset to zero. Otherwise, the original solution is kept unchanged, and its failure value will rise by one. Further, the final step is called the scout bee phase, where a directed food source replaces the exhausted food source (solution with maximum failure). Equation 5 is used to calculate the directed global solution. Equation 6 is used to calculate its generalized oppositional solution. Both solutions are used as an initial weight for the LM algorithm. Thereafter, the DNN is trained using the LM algorithm and tested using equation 3. The exhausted solution is replaced with the best solution.

$${X}_{ind} = \frac{{X}_{best} + {X}_{highest}}{2} + rand * \vert {X}_{best} - {X}_{highest} \vert \qquad ( 5 )$$

where X_{ind} is the new solution produced in the fertile area, rand is a normally distributed random number, X_{best} is the recent global solution, and X_{highest} is the solution with maximum indicator value.

$${x}_{i n d}^{G O} = k \cdot ( {a}_{j} + {b}_{j} ) - {x}_{ind} \qquad ( 6 )$$

where aⱼ=max(X), bⱼ=min(X), and k is a random number in [0, 1]. To sum up, the proposed model uses the fast convergence advantage of the LM algorithm to enhance the searching exploitation and uses the good exploration ability of the GABCds algorithm to avert falling into the trap of the local solution. Thus, new initial weights are fed to the DNN in each iteration. Then, the LM algorithm starts training the DNN. Thereafter, the generated solution is saved if it produces better results, otherwise, it is deleted immediately. In the next iteration, the saved solution is updated using the updated equations of the GABCds algorithm and fed to the LM algorithm. The update equations, together with the framework search of the GABCds algorithm, enhance the model's exploration. In contrast, the LM algorithm enhances its exploitation and convergence. Further, the algorithm 1 depicts a Global Artificial Bee Colony with directed scout (GABCds-LM) model.

Algorithm 1: Global Artificial Bee Colony with directed scout (GABCds-LM)

```
Using Equation 1, set the initial population (both the biases and the weights) to be in the range
[−2.5, 2.5].
Choose the number of input, output, and hidden neurons the DNN should have.
For (i = 1: Max. No. of cycles)
  for (i = 1:SN)
    Using Eq. 2. a new solution is generated X_{new}.
    Train a DNN using the Levenberg-Marquardt algorithm and use the solution
    obtained as the initial weights for the network.
    if fitness (X_{new}) ≥ fitness (Xᵢ):
      Replace Xᵢ by X_{new}
      Set indicator (i) = 1 + indicator(i), failure(i) = 0
    else
      Set failure (i) = 1 + failure(i)
    end if
  end for
Using Eq. 4, calculate the nectar levels of food sources.
  for (i = 1:SN)
    Using the roulette strategy and the selection probability of Eq. 4, some of the
    onlooker bees will be chosen to proceed to the food sources.
    The selected solutions will be updated using Eq. 2.
    Train a DNN using the Levenberg-Marquardt algorithm and use the solution
    obtained as the initial weights for the network.
    if fitness (X_{new} ) ≥ fitness(Xᵢ):
      Replace Xᵢ by X_{new}
      Set indicator(i) = 1+ indicator(i), failure(i) = 0
    else
      Set failure(i) = 1 + failure(i)
  end if
  end for
Identify the solution that has the highest potential for failure.
  IF (max (failure) > limit):
    Locate the food source that has the most significant improvement index.
    Update its value using Eq. 5.
    Using Eq. 6. generate its generalized oppositional solution.
    Use the Levenberg-Marquardt approach to train the DNN using the provided
    solutions.
    Save the best solution among the two solutions instead of the old, depleted
    nourishment source.
  End IF
End For
```

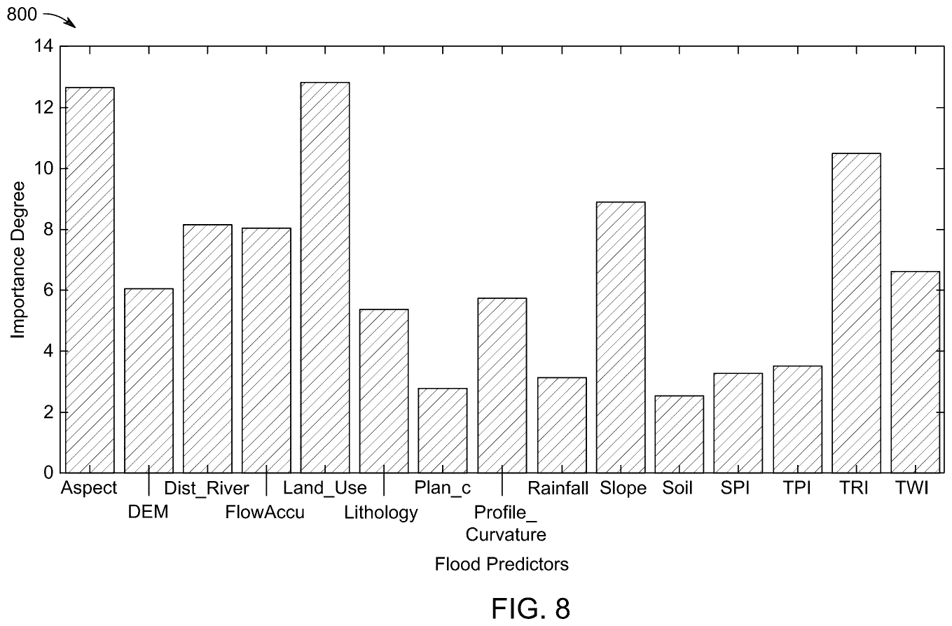

Referring now to FIG. 8, the present disclosure provides a graphical representation 800 of the flood predictors, according to certain embodiments. The graphical representation 800 presents the relative importance of each flood-conditioning factor used by the model over the Jeddah watershed. The x-axis lists the predictors Aspect, DEM (elevation), Distance to river, Flow accumulation, Land use, Lithology, Plan curvature, Profile curvature, Rainfall, Slope, Soil (HSG), SPI, TPI, TRI, and TWI and the y-axis shows an “ImportanceDegree” index. As disclosed, the bars rank the variables by their absolute weights, i.e., by how strongly each factor influenced the trained network's flood/no-flood decisions.

In an embodiment, Land use and Aspect appear as the highest-impact factors, followed closely by TRI (terrain ruggedness); Slope, Distance to river, Flow accumulation, and TWI form the next tier, while DEM/Elevation, Lithology, Rainfall, SPI, TPI, Soil (HSG), and the two curvature measures contribute smaller but still useful signals. The ordering matches the disclosure's discussion that “the five features that impacted the target variables most were land use, aspect, TRI, slope, distance to the river,” with flow accumulation and TWI also identified as influential.

The physical rationale for these results is also documented in the specification such as Land use alters infiltration and runoff production (impervious vs. vegetated cover), Aspect modulates solar exposure and drying, affecting soil moisture retention, the TRI and Slope control runoff concentration and energy, while distance to river represents proximity to inundation corridors, flow accumulation encodes upstream contributing area, TWI highlights topographic water convergence.

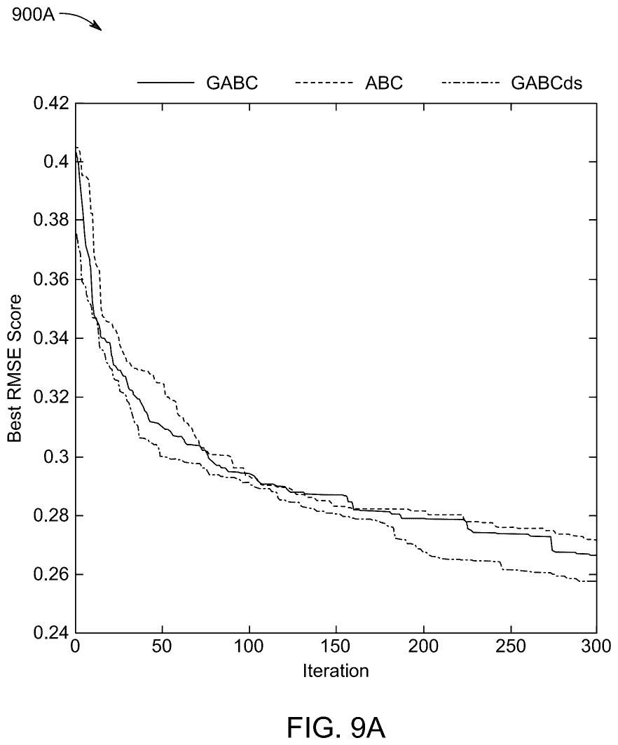

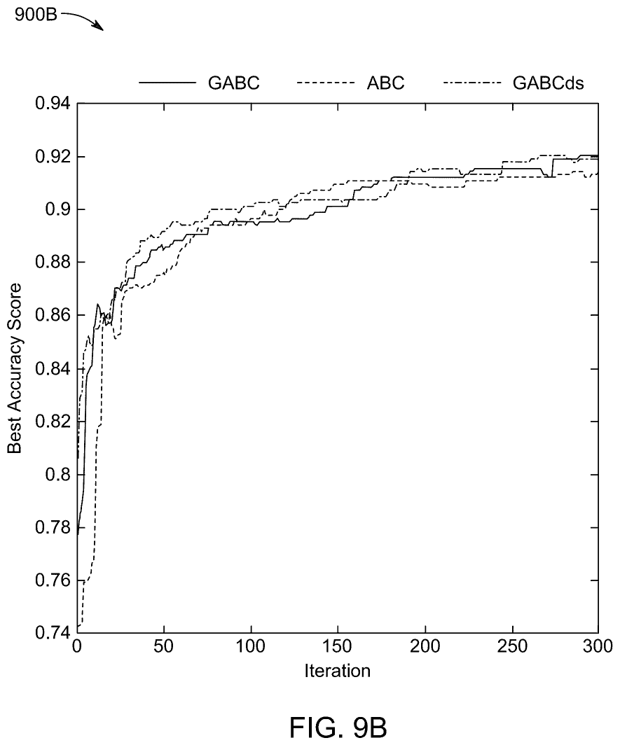

Referring now to FIG. 9A, the present disclosure provides a graphical representation 900A of a convergence rate with respect to Root Mean Square Error (RMSE) score, according to certain embodiments. The graphical representation 900A plots the convergence behavior in objective space, the best RMSE score (y-axis, lower is better) as a function of iteration (x-axis) for three swarm variants used to train the network, ABC, GABC, and the proposed GABCds. The disclosure defines the “convergence curve” as a way to show how quickly performance improves with training, steeper early drops indicate faster convergence, and the curves are averaged over multiple independent runs (≈10) to reflect typical behavior.

Across 0-300 iterations, all three curves descend, showing progressive error reduction, but the GABCds curve falls faster and ends lower than ABC and GABC, i.e., it reaches a smaller final RMSE and maintains a visible margin throughout late iterations. The text explains the outcome among ABC-family methods, GABCds exhibits the fastest convergence rate, evidenced by the steeper slope of its curve in objective (RMSE) space. Methodologically, GABC improves ABC by guiding updates toward the best global solution, and the disclosed GABCds variant further enhances search and replacement, which together yield the improved convergence observed in the graphical representation 900A. The superior convergence in RMSE space is consistent with the downstream classification metrics reported elsewhere in the disclosure, where the GABCds_LM model achieves the best overall performance (e.g., Accuracy 95.24%, AUC 0.95) compared with the other variants.

Referring now to FIG. 9B, the present disclosure provides a graphical representation 900B of a convergence rate with respect to accuracy score, according to certain embodiments. The graphical representation 900B plots the convergence rate in objective-accuracy space for three swarm variants used to train the network ABC, GABC, and the proposed GABCds. The x-axis shows iteration (0-300), the y-axis shows the best accuracy score attained up to that iteration (higher is better). As training proceeds, each curve rises monotonically toward an asymptote, visually conveying how quickly and how far each method improves classification accuracy. The disclosure describes the “convergence curves” and notes that they are averaged over multiple independent runs to reflect typical behavior.

In the early phase (≈0-50 iterations), all methods improve rapidly, with GABCds exhibiting the steepest initial gain, indicating faster discovery of high-quality weight vectors, matching the specification's statement that, among ABC-family algorithms, GABCds shows the fastest convergence rate. During the middle iterations (≈50-200), the curves continue to climb but with diminishing slope, reflecting approach to local optima; GABCds maintains a leading or co-leading trajectory while exhibiting stable improvements, consistent with the method's directed-scout replacement and global-best guidance that balance exploration and exploitation. By the late phase (≈200-300), all three variants asymptote near ≈0.92 accuracy, demonstrating comparable final performance, with GABCds reaching strong accuracy earlier and remaining competitive or superior over most of the horizon. Taken together with the RMSE convergence (FIG. 9A), the plot substantiates that GABCds accelerates training while preserving top-tier accuracy aligning with the disclosure's overall results where the GABCds_LM hybrid attains the best end-to-end metrics (e.g., Accuracy≈95.24%, AUC≈0.95).

Referring now to FIG. 10, the present disclosure provides a graphical representation 1000 of a ROC and an AUC on a testing dataset, according to certain embodiments. The graphical representation 1000 plots the ROC curves on the testing dataset for the four classifiers evaluated in the disclosure LM, ABC_LM, GABC_LM, and the proposed GABCds_LM. The x-axis is the false-positive rate (FPR), and the y-axis is the true-positive rate (TPR), the ROC is computed from these two statistics, and the AUC summarizes threshold-independent performance on a 0-1 scale (closer to 1=more accurate).

Each curve in 1000 shows how TPR trades off against FPR as the decision threshold is swept. The AUC values printed in the legend quantify the curves, LM=0.80, ABC_LM=0.93, GABC_LM=0.94, and GABCds_LM=0.95. These are the same AUCs reported in the specification's results table and narrative, which identify GABCds_LM as the best overall model on the test set. The curves that bow closer to the upper-left (high TPR at low FPR) are better, accordingly, GABCds_LM dominates or matches the others across thresholds and achieves the highest AUC (0.95), while LM is weakest with AUC 0.80. The FIG. 10 therefore corroborates the disclosure's central claim that the hybrid GABCds+LM training yields the most robust flood/no-flood classifier among the tested alternatives.

In an embodiment, various measurements are used to assess the performance of the flood susceptibility models on the training and testing datasets, respectively. The metrics are ROC and AUC, F1_measure, precision, sensitivity, specificity, and accuracy. The output of the network is a value of probability between 0 and 1. If it is larger than the threshold of 0.5, the prediction of the sample is considered as Flood. Otherwise, it is considered that no flood occurred. From the confusion matrix, we can compute them as in equation 7 to equation 11.

$$AUC = \sum T P + \sum \frac{T N}{P} + N \qquad ( 7 )$$

$$Sensitivity = \frac{T P}{T P + F N} \qquad ( 8 )$$

$$Precision = \frac{T P}{T P + F P} \qquad ( 9 )$$

$$Specificity = \frac{T N}{T N + F P} \qquad ( 10 )$$

$$F - score = \frac{2 * Precision * Sensitivity}{Prec i sion + Sensitivity} \qquad ( 11 )$$

The ROC is calculated using two statistical values: the false positive and the true positive. Accordingly, Equation 7 is used to assess the model's performance using the area under the ROC curve measure. AUC values range from 0 to 1, the closer they are to 1, the more accurate the model is. In other words, a higher AUC value indicates the agreement or accuracy between the flood susceptibility model and reality. Further, a Table 1 depicts a performance evaluation of the proposed models compared to other models on the testing dataset.

TABLE 1

| Model | TP | TN | FP | FN | Precision | Sensitivity | Specificit | F score | Accuracy | AUC |
|---|---|---|---|---|---|---|---|---|---|---|
| LM | 33 | 34 | 11 | 6 | 75% | 84.62% | 85% | 79.52% | 79.76% | 0.8 |
| ABC_LM | 36 | 43 | 2 | 3 | 94.74% | 92.31% | 93.48% | 93.51% | 94.05% | 0.94 |
| GABC_LM | 37 | 42 | 3 | 2 | 92.5% | 94.87% | 95.45% | 93.67% | 94.05% | 0.94 |
| GABCds_LM | 37 | 43 | 2 | 2 | 94.87% | 94.87% | 95.56% | 94.87% | 95.24% | 0.95 |

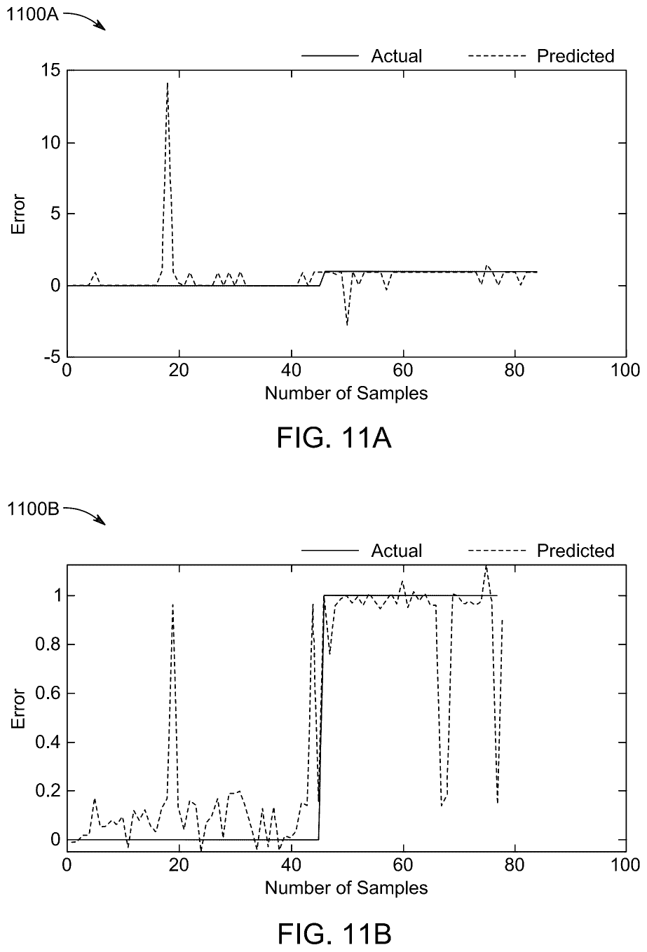

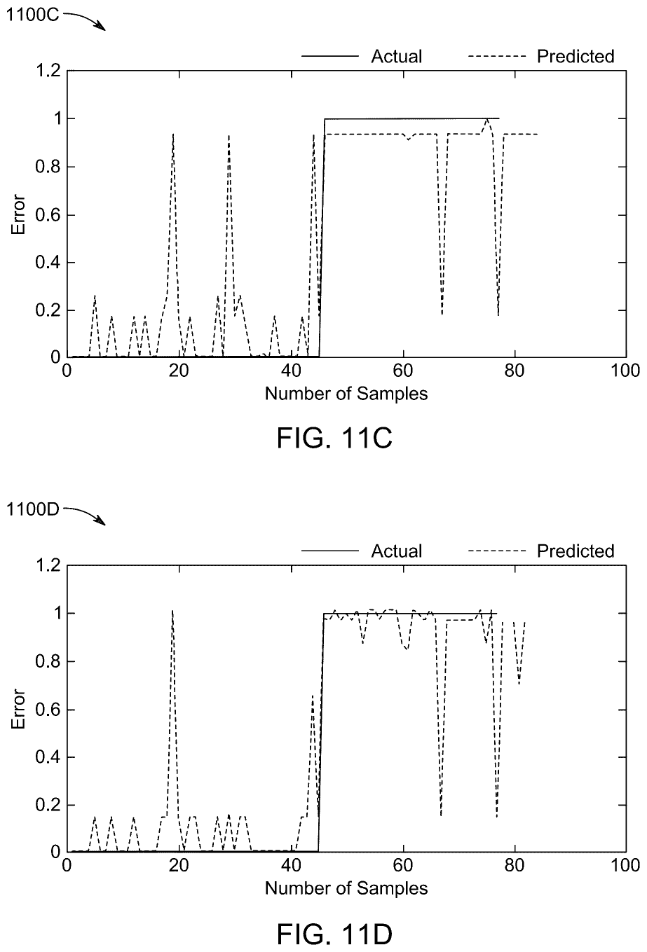

Referring now to FIG. 11A, the present disclosure provides a graphical representation 1100A of actual and predicted values of the testing data for the LM model, according to certain embodiments. The graphical representation 1100A visualizes how the stand-alone LM model behaves on the testing set by plotting, for each held-out sample (x-axis, “Number of samples”), the residual/error relative to the ground truth (y-axis, “Error”). The solid trace corresponds to the actual (zero-error baseline), and the dashed trace shows the predicted residuals produced by the LM-trained network. Ideally, the solid curve would hug the dashed baseline, departures from zero mark misfits or misclassifications.

The LM curve exhibits large excursions, notably a tall positive spike around sample ~20 and several negative dips near ~55-60-indicating unstable residuals and systematic misestimation for portions of the test set. The qualitative behavior is consistent with the specification's narrative that, when actual versus predicted values are compared, the LM model “falls short,” with sizeable deviations from the true values. The weaknesses seen in 1100A are corroborated quantitatively by the test-set confusion-matrix results reported in the disclosure for LM (TP=33, TN=34, FP=11, FN=6), which yield substantially lower summary metrics (e.g., Accuracy≈79.76%, AUC=0.80) than the hybrid methods.

FIG. 11A serves as a diagnostic complement to ROC/AUC and accuracy tables. It makes the LM model's error structure visible sample-by-sample and motivates the disclosure's hybridization strategy (GABCds+LM), which the disclosure shows to be markedly more stable and accurate on the same test data.

Referring now to FIG. 11B, the present disclosure provides a graphical representation 1100B of actual and predicted values of the testing data for the ABC_LM model, according to certain embodiments. The graphical representation 1100B visualizes the test-set predictions of the ABC_LM model against the ground-truth labels. Along the x-axis the samples are indexed in their evaluation order (“Number of samples”). The y-axis shows the normalized class value/score (0≈No Flood, 1≈Flood). The solid trace is the actual label sequence encoded as 0/1, the dashed trace is the model's predicted score for each sample. A good classifier yields a dashed curve that hugs the solid step-like ground truth, with only small deviations. The disclosure uses these “actual vs. predicted” plots to visually judge model stability on unseen data.

As shown, the ABC_LM tracks the ground truth closely, scores stay near 0 for early non-flood samples and rise to ≈1 over the flood segment, with only isolated spikes/dips, the few departures corresponding to the limited number of false decisions. The behavior matches the reported test metrics for ABC_LM (TP=36, TN=43, FP=2, FN=3, Accuracy≈94.05%, AUC=0.94), confirming that errors are infrequent and the hybrid (ABC+LM) training yields a stable predictor on the held-out set.

Referring now to FIG. 11C, the present disclosure provides a graphical representation 1100C of actual and predicted values of the testing data for the GABC_LM model, according to certain embodiments. The graphical representation 1100C shows how the GABC_LM model's predictions track the ground-truth labels on the testing set. The x-axis indexes the held-out samples (“Number of samples”), the y-axis is the class value/score (≈0 for No Flood, ~1 for Flood). The solid line is the step-like actual sequence, and the dashed line is the model's predicted score for each sample. In these “actual vs. predicted” diagnostics, a well-trained classifier has a dashed trace that hugs the solid baseline at 0 for non-flood samples and rises to ~1 over flood samples, with only small excursions.

As plotted, the GABC_LM adheres closely to the ground truth, predictions remain near 0 through the early non-flood portion, then jump to ~1 when the sequence enters flood cases. Only a few spikes and brief dips appear, isolated false positives in the early segment and rare near misses (brief drops) within the flood segment, indicating generally stable generalization on unseen data. The visual behavior aligns with the model's strong threshold-independent performance reported elsewhere AUC=0.94 on the test set (higher is better), demonstrating high discriminative power relative to LM-only and comparable to ABC_LM while trailing the best GABCds_LM variant.

Referring now to FIG. 11D, the present disclosure provides a graphical representation 1100D of actual and predicted values of the testing data for the GABCds_LM model, according to certain embodiments. The graphical representation 1100D visualizes the test-set behavior of the GABCds_LM model by plotting, for each held-out sample on the x-axis (“Number of samples”), the model's predicted class score (blue) against the actual 0/1 ground truth (red). In these “actual vs. predicted” diagnostics, a well-trained classifier tracks the solid step-like sequence closely, near 0 for No Flood cases and near 1 for Flood cases, so departures mark misestimates.

As shown, the GABCds_LM adheres tightly to the ground truth, predictions remain ~0 across the early non-flood portion, then switch to ~1 over the flood segment with only a few brief spikes/dips (isolated false decisions). The sparsity and short duration of these excursions indicate stable generalization on unseen data and visually distinguish GABCds_LM from weaker baselines. The sample-level fit aligns with the quantitative test metrics reported for the same model, Accuracy≈95.24%, Precision/Sensitivity/Specificity≈94.9-95.6%, with only 2 false positives and 2 false negatives and with its AUC=0.95, the highest among the evaluated methods. Together, these substantiate that the GABCds (directed-scout) exploration+LM local refinement produces the most accurate flood/no-flood classifier in the disclosure.

In an embodiment, the table 2 depicts comparison between the proposed models with the state-of-the-art studies in flood susceptibility mapping considering different models and different areas.

TABLE 2

| Source | Model | AUC | Accuracy | Study Area |
|---|---|---|---|---|
| (Islam et al., | Dagging | 0.87 | | Teesta River basin, the |
| 2021) | | | | northern region of Bangladesh |
| (Ghosh et al., | XGBoost | 0.92 | | lower part of Raidak river basin in |
| 2022) | | | | the Alipurduar and Cooch Behar |
| | | | | district of West |
| | | | | Bengal, Indi |
| (Prasad et al., | AB-RF | 0.94 | | central west coast of India |
| 2021) | | | | |
| (Ilia et al., | SE-RF | 0.87 | 0.84 | Island of Rhodes, Greece |
| 2022) | | | | |
| (Costache et | ANFIS-CF | 0.89 | 0.91 | Trotus River basin in Romania |
| al., 2020c) | | | | |
| (Shahabi et | Bagging | 0.80 | 0.99 | Haraz watershed in northern Iran |
| al., 2020) | Tree-Cubic | | | |
| | KNN | | | |
| (Band et al., | ERT | 0.82 | | Kalvan watershed in Markazi |
| 2020) | | | | Province, Iran |
| (Ha et al., | DecorateREPT | 0.99 | 0.96 | the road network National Highway 6 |
| 2021) | MultiBoost | 0.99 | 0.96 | in Hoa Binh province, Vietnam |
| | AB-REPT | | | |
| (Elmahdy et | BRT | 0.92 | | the northern part of the United Arab |
| al., 2020) | | | | Emirates (NUAE) |
| (Costache | FSVM | 0.91 | | Prahova river basin, Romania |
| and Tien Bui, | | | | |
| 2019) | | | | |
| (Meliho et | KNN | 0.99 | | Souss watershed located in southern |
| al., 2021) | | | | Morocco |
| (Pandey et | CART-EBF | 0.82 | | The part of the Middle Ganga Plain |
| al., 2021) | | | | (MGP) |
| (Al-Abadi, | AdaBoost | 0.99 | 0.95 | an arid region of southern Iraq |
| 2018) | | | | |
| (Vojtek et | BRT | | 0.91 | Topla river basin, Slovakia |
| al., 2021) | | | | |
| (Saha et al., | HP-SVR | 0.88 | 0.89 | Koiya River basin, Eastern India |
| 2021) | | | | |
| (Yaseen et | LR-SVM- | | 0.98 | arid region of Pakistan |
| al., 2022) | MLP | | | |
| (Rana and | WOE-ANN | 0.97 | 0.92 | The Uttarakhand is a Himalayan state |
| Mahanta, | | | | |
| 2022) | | | | |
| (Costache et | U-WOE | 0.95 | 0.94 | Putna river basin from Romania |
| al., 2022) | SGD-WOE | | | |
| | CSForest- | | | |
| | WOE | | | |
| (Costache et | kNN-AHP | 0.90 | 0.81 | the upper and middle parts of the |
| al., 2020b) | | | | Prahova river basin is in the south- |
| | | | | central part of Romania |
| (El-Haddad | GLM | 0.86 | | Wadi Qena Basin, Egypt |
| et al., 2020) | | | | |
| (Satarzadeh | DBN-PSO | 0.96 | | western Iran |
| et al., 2021) | | | | |
| (Talukdar et | BgM5P | 0.95 | | Teesta River basin, Bangladesh |
| al., 2020) | | | | |
| (Costache et | DNN-AHP | 0.95 | 0.96 | catchment area in south-eastern |
| al., 2020) | | | | Romania |
| (Youssef et | RF | 0.81 | | area between Safaga and Ras Gharib |
| al., 2022) | | | | cities, Red Sea, Egypt |
| Present | GABCds_LM | 0.95 | 0.95 | Jeddah, Saudi Arabia |
| Disclosure | | | | |

Islam, A. R. M. T., Talukdar, S., Mahato, S., Kundu, S., Eibek, K. U., Pham, Q. B., Kuriqi, A., Linh, N. T. T., 2021. Flood susceptibility modelling using advanced ensemble machine learning models. Geosci. Front. 12, 101075 https://doi.org/10.1016/J. GSF.2020.09.006.
Ghosh et al., 2022: Ghosh, S., Saha, S., Bera, B., 2022. Flood susceptibility zonation using advanced ensemble machine learning models within Himalayan foreland basin. Nat. Hazards Res.
Prasad et al., 2021: Prasad, P., Loveson, V. J., Das, B., Kotha, M., 2021. Novel ensemble machine learning models in flood susceptibility mapping. Geocarto Int. https://doi.org/10.1080/10106049.2021.1892209.
Ilia et al., 2022: Ilia, I., Tsangaratos, P., Tzampoglou, P., Chen, W., Hong, H., 2022. Flash flood susceptibility mapping using stacking ensemble machine learning models. Geocarto Int. 1-27.
Costache et al., 2020c: Costache, R., Tíncu, R., Elkhrachy, I., Pham, Q. B., Popa, M. C., Diaconu, D. C., Avand, M., Costache, I., Arabameri, A., Bui, D. T., 2020c. New neural fuzzy-based machine learning ensemble for enhancing the prediction accuracy of flood susceptibility mapping. 65, 2816-2837. 10.1080/02626667.2020.1842412.
Shahabi et al., 2020: Shahabi, H., Shirzadi, A., Ghaderi, K., Ghaderi, K., Omidvar, E., Al-Ansari, N., Al-Ansari, N., Clague, J. J., Geertsema, M., Khosravi, K., Amini, A., Bahrami, S., Rahmati, O., Habibi, K., Mohammadi, A., Nguyen, H., Nguyen, H., Melesse, A. M., Ahmad, B. B., Ahmad, A., 2020. Flood detection and susceptibility mapping using sentinel-1 remote sensing data and a machine learning approach: hybrid intelligence of bagging ensemble based on K-nearest neighbor classifier. Remote Sens. https://doi.org/10.3390/rs12020266.
Band et al., 2020: Band, S. S., Janizadeh, S., Pal, S. C., Saha, A., Chakrabortty, R., Melesse, A. M., Mosavi, A., 2020. Flash flood susceptibility modeling using new approaches of hybrid and ensemble tree-based machine Remote Sens. learning algorithms. https://doi.org/10.3390/rs12213568.
Al-Abadi, 2018: Al-Abadi, A. M., 2018. Mapping flood susceptibility in an arid region of southern Iraq using ensemble machine learning classifiers: a comparative study. Arab. J. Geosci. https://doi.org/10.1007/s12517-018-3584-5.
Satarzadeh et al., 2021: Satarzadeh, E., Sarraf, A., Hajikandi, H., Sadeghian, M. S., Sadeghian, M. S., 2021. Flood hazard mapping in western Iran: assessment of deep learning vis-á-vis machine learning models. Nat. Hazards. https://doi.org/10.1007/s11069-021-05098-6

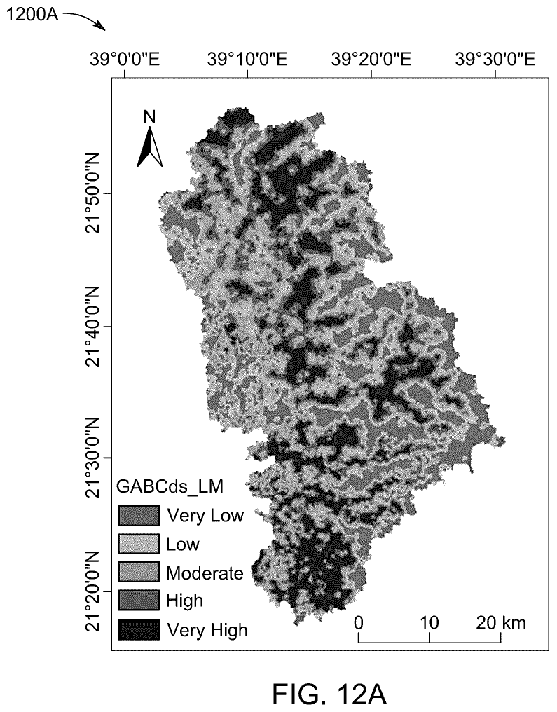

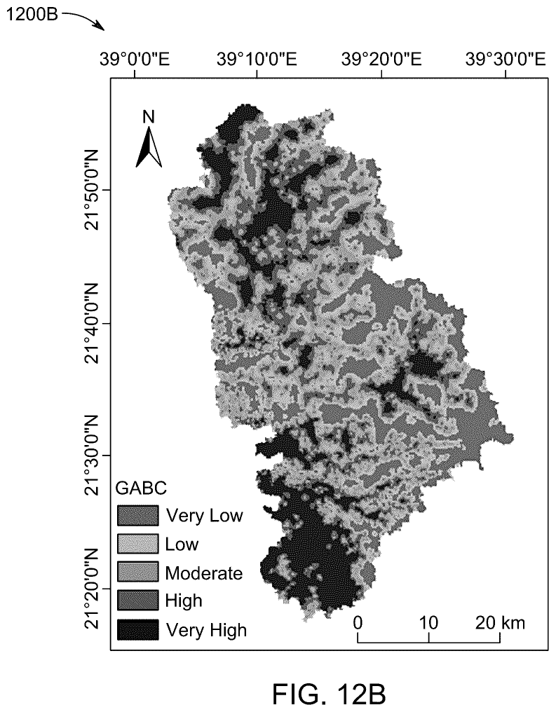

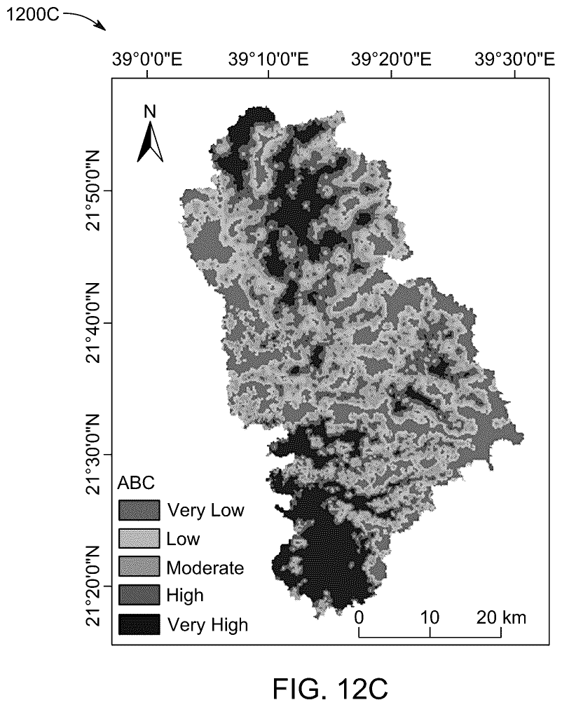

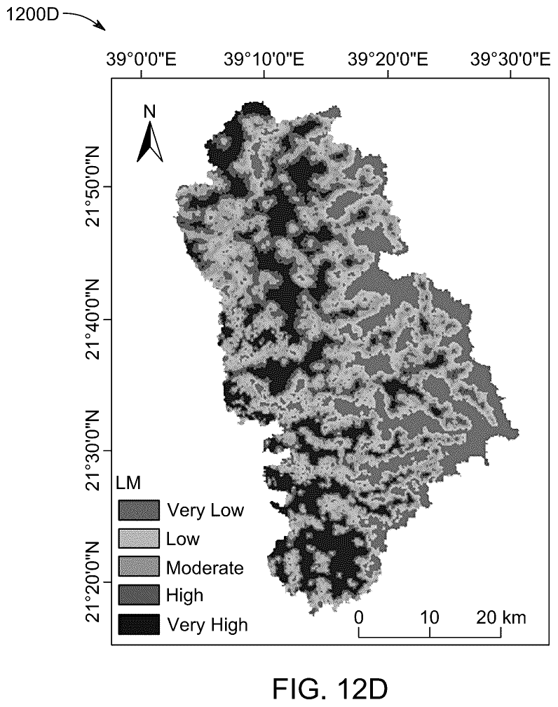

Referring now to FIG. 12A, the present disclosure provides a pictorial representation 1200A of a flood susceptibility mapping of the Jeddah based on the GABCds_LM model, according to certain embodiments. The pictorial representation 1200A is georeferenced with latitude/longitude ticks, a north arrow, and a 0-20 km scale. Pixel-wise DNN outputs (probability of flood occurrence) were classified into five ordinal classes, Very low, Low, Moderate, High, and Very high using a quantile scheme, which is the classifier adopted in the specification for susceptibility mapping. First, a flood inventory (141 flood and 141 non-flood points derived from historical reports and Sentinel-1 SAR differencing) and 15 conditioning factors (slope, lithology, altitude, distance to river, soil group, profile and plan curvature, aspect, flow accumulation, rainfall, land use, TRI, SPI, TWI, and TPI) are assembled and split 70/30 for training/validation. The GABCds metaheuristic explored candidate DNN weight sets while LM performed fast local refinement at every iteration, the best model is then used to infer a susceptibility probability for every 30 m cell across the ~1,821 km².

The GABCds_LM model that produced the pictorial representation 1200A achieved the highest test performance among all variants (Accuracy 95.24%, AUC 0.95, with only 2 FP and 2 FN), indicating that the zoning is supported by strong, threshold-independent discrimination on unseen data. Accordingly, FIG. 12A may be relied upon for prioritizing mitigation (e.g., channel maintenance, early-warning assets, development controls) in the identified High and Very-high belts across Jeddah.

Referring now to FIG. 12B, the present disclosure provides a pictorial representation 1200B of the flood susceptibility mapping of the Jeddah based on the GABC model, according to certain embodiments. The pictorial representation 1200B shows the flood-susceptibility zoning for the Jeddah watershed when the Deep Neural Network (DNN) is trained with the Gbest-guided Artificial Bee Colony (GABC) optimizer. Cells are classified into five ordinal classes, Very low, Low, Moderate, High, Very high using the quantile scheme adopted in the disclosure for susceptibility mapping.

The same inventory of flood/non-flood points and the same set of terrain, hydrologic, and land-use predictors are used basin-wide, the DNN's pixel-wise probabilities (flood vs. no-flood) are inferred across the ~1,821 km² watershed and then binned into the five classes noted above. In FIG. 12B, the DNN weights are obtained solely by the GABC global search (i.e., without LM fine-tuning), which serves as a benchmark against the hybrid approach. Darker tones (High/Very high) concentrate along wadi corridors and low-lying convergence zones that carry flow toward the Red Sea, while lighter tones (Low/Very low) dominate higher, steeper, or rocky uplands that rapidly shed runoff. The spatial pattern reflects the watershed's east-west relief from mountain ranges (up to ~675 m) in the east to the coastal plain (≈0 m) in the west and the known role of these corridors in past flash-flood events.

Referring now to FIG. 12C, the present disclosure provides a pictorial representation 1200C of the flood susceptibility mapping of the Jeddah based on the ABC model, according to certain embodiments. The pictorial representation 1200C shows the flood-susceptibility zoning produced when the DNN is trained with the standard Artificial Bee Colony (ABC) optimizer. Pixelwise probabilities output by the network are converted to five ordinal classes, Very low, Low, Moderate, High, Very high using the quantile scheme adopted in the disclosure for susceptibility mapping.

The same inventory of flood/non-flood points and the 15 conditioning factors (terrain, hydrography, soils, land use, etc.) are used to score every 30-m cell across the ~1,821 km² basin; the ABC-trained weights are then applied to render this map. High/Very-high belts align with wadi corridors and low-lying convergence zones that drain westward, whereas Low/Very-low zones dominate the steeper, rockier uplands that shed runoff quickly, patterns consistent with the watershed's east-to-west relief from mountains (~675 m) to coastal plain (~0 m).

Referring now to FIG. 12D, the present disclosure provides a pictorial representation 1200D of the flood susceptibility mapping of the Jeddah based on the LM model, according to certain embodiments. The pictorial representation 1200D depicts the susceptibility zoning when the DNN is trained only with the LM (no swarm search). Again, cell-wise probabilities are classified into the same five susceptibility classes for direct comparability with other models. As documented in the results, the LM-only model underperforms the metaheuristic-guided variants (test AUC≈0.80; lower accuracy and more false decisions), which explains the relatively noisier agreement with observed flood locations compared with hybrid maps.

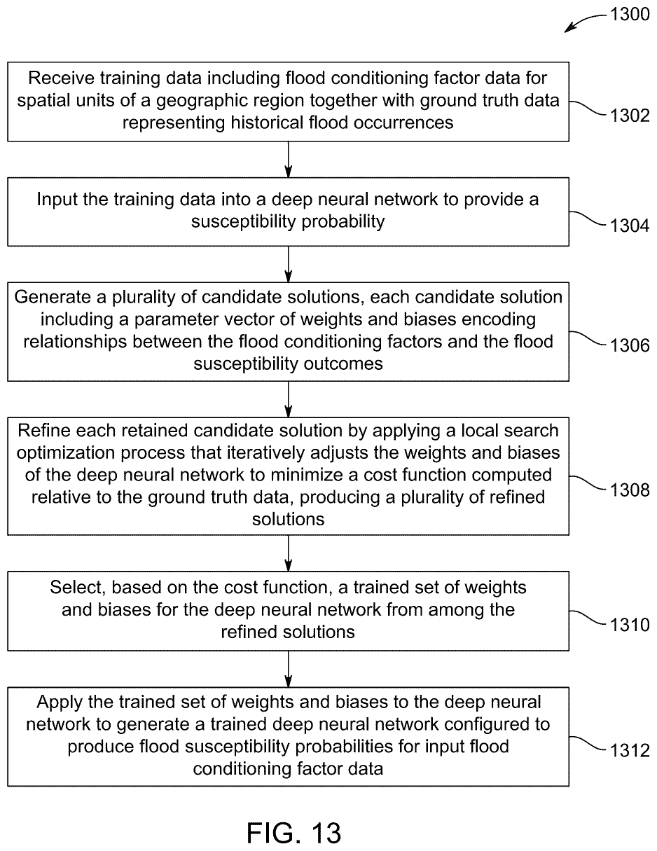

FIG. 13 is an exemplary flow diagram of a method for training a deep neural network for flood susceptibility prediction, according to certain embodiments. The method 1300 may be implemented by the computing device 102 of the system 100.

At step 1302, training data including flood conditioning factor data for spatial units of a geographic region together with ground truth data representing historical flood occurrences is received. For each spatial unit, the conditioning factors include a feature vector derived from remote sensing and GIS layers, such as terrain and morphometric indices (elevation, slope, aspect, curvature, flow accumulation, drainage density, distance to channel/coastline, TWI/SPI), surface and land-use attributes (land-cover class, imperviousness, vegetation or built-up indices), soil/lithology classes, and event-scale hydrometeorology (e.g., storm totals, peak intensity). The ground truth is assembled from historical flood inventories such as SAR-/optical-based inundation maps or vetted incident reports and encoded as labels per unit (binary flooded/non-flooded or frequency/probability where available). Receiving the data further includes aligning sources to a common projection and resolution, spatially joining labels to features, masking to the study boundary, and performing basic integrity checks (e.g., handling missing/invalid values and obvious outliers) so that each spatial unit is associated with a complete, quality-controlled pair (feature vector, label) suitable for subsequent model training and evaluation.

At step 1304, the training data is input into a deep neural network to provide a susceptibility probability. The prepared training data (feature vectors per spatial unit paired with flood/no-flood labels) is supplied to a deep neural network configured for probabilistic classification. Continuous inputs are normalized, and categorical inputs (e.g., lithology or land-use classes) are embedded or one-hot encoded, after which the concatenated tensor is propagated through multiple hidden layers (e.g., fully connected layers with ReLU activations, optional batch normalization, and dropout for regularization).

At step 1306, a plurality of candidate solutions is generated (using Eq. 1), each candidate solution including a parameter vector of weights and biases encoding relationships between the flood conditioning factors and the flood susceptibility outcomes. The generating includes sampling and perturbing the parameter vectors across the solution space to generate updated candidate solutions and refining the updated candidate solutions using local optimization process to generate refined candidate solutions. The refined solutions are evaluated using a cost-function of the DNN and a selected subset of refined solutions and/or the candidate solutions are retained. Each candidate solution is associated with an improvement indicator that is incremented when a candidate solution is replaced by a refined candidate solution that yields an improved cost value compared to the candidate solution, and the improvement indicator is used to guide generation of replacement candidate solutions.

In some embodiments, generating the plurality of candidate solutions includes perturbing (employee bee phase) each candidate solution (e.g., candidate solution A) within a neighborhood of its current parameter values to produce updated candidate solutions (e.g., candidate A*). In some embodiments, the perturbation may be performed using Eq. 2. The method includes refining the updated candidate solution by applying the local search optimization process (e.g., LM algorithm), which trains the DNN using the updated candidate solution until a cost function is minimized (e.g., as described in step 1308). The local optimization process yields a refined solution (e.g., refined solution A′). The method includes replacing the candidate solution (e.g., A) with the refined candidate solution (e.g., A′) if the refined candidate solution yields an improved cost value (e.g., cost (A′)<cost (A), otherwise retaining the candidate solution and incrementing a failure count associated with the candidate solution.

Further, generating the plurality of candidate solutions includes computing a selection probability (onlooker bee phase) for each candidate solution based on the cost function (e.g., using Eqs. 3 and 4). The method includes probabilistically selecting candidate solutions according to the selection probabilities. Further, the method includes perturbing each selected candidate solution to produce an updated candidate solution. Further, the method includes refining the updated candidate solution by applying the local search optimization process (e.g., as described in step 1308), which trains the DNN using the updated candidate solution until the cost function is minimized (e.g., as described in step 1308). The local optimization process yields a refined candidate solution. The method further includes replacing the selected candidate solution with the refined candidate solution if the refined candidate solution yields an improved cost value.

In an embodiment, generating the plurality of candidate solutions further includes identifying a candidate solution having a failure count that exceeds a predefined threshold (scout bee phase). Further, the method includes generating a replacement candidate solution for the identified candidate solution. The replacement candidate solution includes using a directed update relative to a best-performing candidate solution and an oppositional update relative to an existing candidate solution. The method includes refining the replacement candidate solution by applying the local search optimization process (e.g., as described in step 1308) to produce a refined candidate solution. Further, the method includes replacing the identified candidate solution with the refined candidate solution if the refined candidate solution reduces the cost function.

At step 1308, each retained candidate solution is refined by applying a local search optimization process that iteratively adjusts the weights and biases of the deep neural network to minimize a cost function computed relative to the ground truth data, thereby producing a plurality of refined solutions. In an embodiment, refining each retained candidate solution by the local search optimization process includes initializing the deep neural network with the retained candidate solution and iteratively updating the weights and biases until the cost function converges below a predetermined threshold or a maximum number of iterations is reached.

At step 1310, a trained set of weights and biases are selected for the deep neural network from among the refined solutions or candidate solutions that have been retained based on the cost function. In some embodiments, retained solutions include those refined solutions having improved yield cost values compared to their corresponding candidate solutions (e.g., cost (refined solution A′)<cost (candidate solution A) and the candidate solutions whose refined version that did not yield improved cost values. In an embodiment, selecting the trained set of weights and biases includes retaining, from among the refined candidate solutions and the candidate solutions, a solution associated with the lowest value of the cost function. Further, generating the plurality of candidate weight and bias solutions is performed using a Gbest-guided Artificial Bee Colony with directed scout (GABCds) algorithm, and refining the retained candidate solutions is performed using a Levenberg-Marquardt algorithm.

At step 1312, the trained set of weights and biases are applied to the DNN to generate a trained DNN configured to produce flood susceptibility probabilities for input flood conditioning factor data. Further, using the predicted probabilities, the embodiments may generate geospatial flood susceptibility map of the geographic region with zones corresponding to the susceptibility categories. The susceptibility categories may be binary (e.g., “Flood” or “No Flood”) or more than two categories (e.g., low, very low, medium, high, very high, etc.), which may be derived based on the probability value output by the DNN.

The DNN may be placed in evaluation mode so that stochastic training behaviors are disabled (e.g., dropout off, batch-normalization uses learned running means/variances), and the end-to-end inference pipeline is finalized by attaching the same input preprocessing used during training (feature ordering, scaling/normalization, categorical encoders).

In an embodiment, the method 1300 may include applying the trained deep neural network to flood conditioning factor data of a specified geographic region to generate susceptibility probability values for spatial units of the geographic region. Further, the method 1300 include classifying the susceptibility probability values into a plurality of susceptibility categories. The method include generating a geospatial flood susceptibility map of the geographic region with zones corresponding to the susceptibility categories.

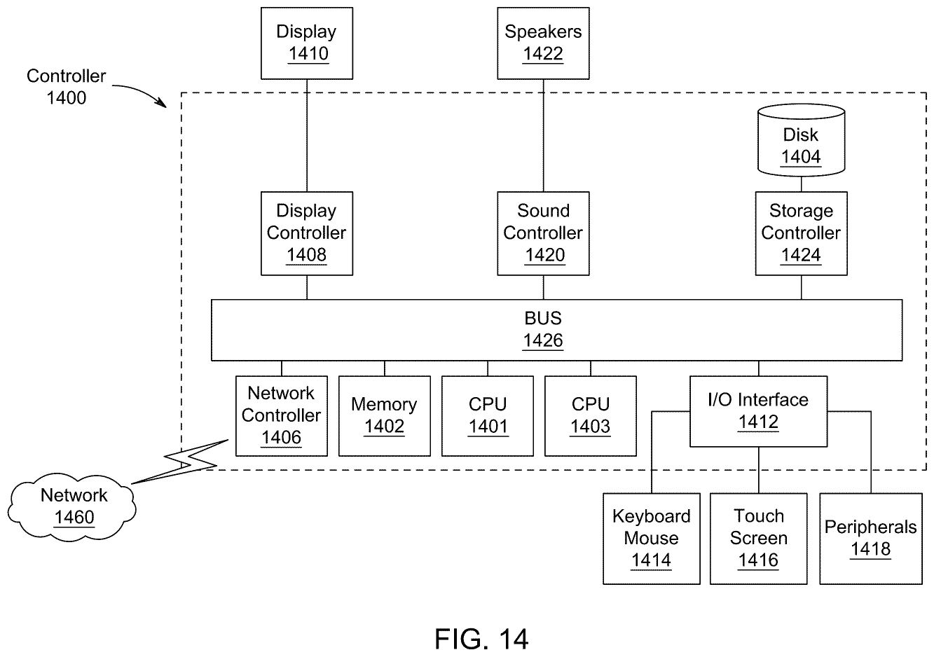

Next, further details of the hardware description of the computing environment according to exemplary embodiments are described with reference to FIG. 14. In FIG. 14, a controller 1400 is described as representative of the system 100 of FIG. 1 in which the controller 1400 is a computing device which includes a CPU 1401 which performs the processes described above/below. The process data and instructions may be stored in a memory 1402. These processes and instructions may also be stored on a storage medium disk 1404 such as a Hard Disk Drive (HDD) or a portable storage medium or may be stored remotely.

Further, the claims are not limited by the form of the computer-readable media on which the instructions of the inventive process are stored. For example, the instructions may be stored on Compact Disks (CDs), Digital Versatile Discs (DVDs), in a Flash memory, a RAM, a ROM, a Programmable Read-Only Memory (PROM), an EPROM, an Electrically Erasable Programmable Read-Only Memory (EEPROM), a hard disk or any other information processing device with which the computing device communicates, such as a server or a computer.

Further, the claims may be provided as a utility application, background daemon, or component of an operating system, or combination thereof, executing in conjunction with the CPU 1401, a CPU 1403 and an operating system such as a Microsoft Windows 7, a Microsoft Windows 10, a UNIX, a Solaris, a LINUX, an Apple MAC-OS and other systems known to those skilled in the art.

The hardware elements in order to achieve the computing device may be realized by various circuitry elements, known to those skilled in the art. For example, the CPU 1401 or the CPU 1403 may be a Xenon or a Core processor from Intel of America or an Opteron processor from Advanced Micro Devices (AMD) of America, or may be other processor types that would be recognized by one of ordinary skill in the art. Alternatively, the CPU 1401, the CPU 1403 may be implemented on a Field-Programmable Gate Array (FPGA), an Application-Specific Integrated Circuit (ASIC), a Programmable Logic Device (PLD) or using discrete logic circuits, as one of ordinary skill in the art would recognize. Further, the CPU 1401, the CPU 1403 may be implemented as multiple processors cooperatively working in parallel to perform the instructions of the inventive processes described above.

The computing device in FIG. 14 also includes a network controller 1406, such as an Intel Ethernet Professional (PRO) network interface card from an Intel Corporation of America, for interfacing with a network 1460. As can be appreciated, the network 1460 can be a public network, such as the Internet, or a private network such as a LAN or a WAN, or any combination thereof and can also include a PSTN or an Integrated Services Digital Network (ISDN) sub-networks. The network 1460 can also be wired, such as an Ethernet network, or can be wireless such as a cellular network including EDGE, Third Generation (3G) and Fourth Generation (4G) wireless cellular systems. The wireless network can also be a WiFi, a Bluetooth, or any other wireless form of communication that is known.

The computing device further includes a display controller 1408, such as a NVIDIA GeForce Giga Texel Shader eXtreme (GTX) or a Quadro graphics adaptor from a NVIDIA Corporation of America for interfacing with a display 1410, such as a Hewlett Packard HPL2445w Liquid Crystal Display (LCD) monitor. A general purpose I/O interface 1412 interfaces with a keyboard and/or mouse 1414 as well as a touch screen panel 1416 on or separate from display 1410. The general purpose I/O interface 1412 also connects to a variety of peripherals 1418 including printers and scanners, such as an OfficeJet or DeskJet from HP.

A sound controller 1420 is also provided in the computing device such as a Sound Blaster X-Fi Titanium from Creative, to interface with speakers/microphone 1422 thereby providing sounds and/or music.

A general purpose storage controller 1424 connects the storage medium disk 1404 with a communication bus 1426, which may be an Industry Standard Architecture (ISA), an Extended Industry Standard Architecture (EISA), a Video Electronics Standards Association (VESA), a Peripheral Component Interconnect (PCI), or similar, for interconnecting all of the components of the computing device. A description of the general features and functionality of the display 1410, keyboard and/or mouse 1414, as well as the display controller 1408, the general purpose storage controller 1424, the network controller 1406, the sound controller 1420, and the general purpose I/O interface 1412 is omitted herein for brevity as these features are known.

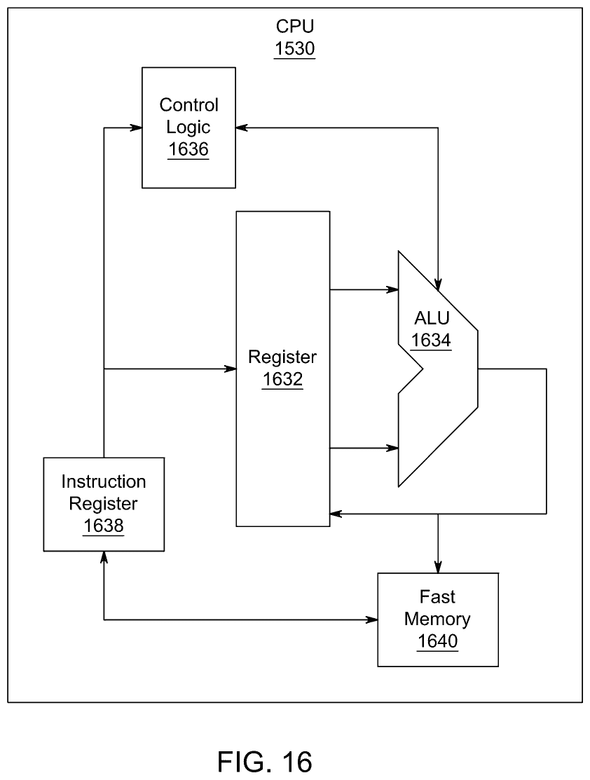

The exemplary circuit elements described in the context of the present disclosure may be replaced with other elements and structured differently than the examples provided herein. Moreover, circuitry configured to perform features described herein may be implemented in multiple circuit units (e.g., chips), or the features may be combined in circuitry on a single chipset, as shown on FIG. 16.

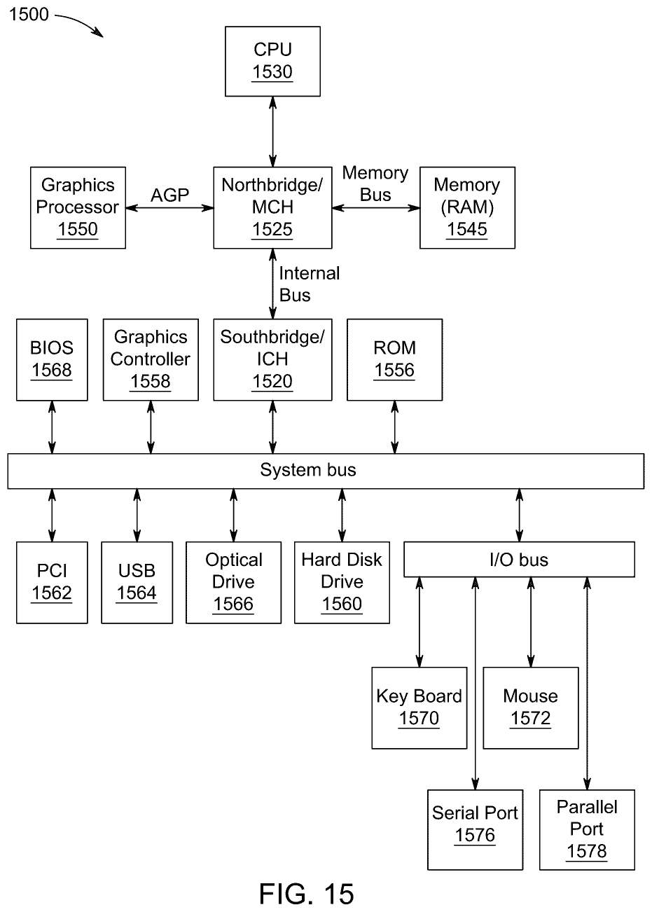

FIG. 15 shows a schematic diagram of a data processing system 1500, according to certain embodiments, for performing the functions of the exemplary embodiments. The data processing system 1500 is an example of a computer in which code or instructions implementing the processes of the illustrative embodiments may be located.

In FIG. 15, the data processing system 1500 employs a hub architecture including a North Bridge and a Memory Controller Hub (NB/MCH) 1525 and a south bridge and an I/O Controller Hub (SB/ICH) 1520. The CPU 1530 is connected to the NB/MCH 1525. The NB/MCH 1525 also connects to a memory 1545 via a memory bus and connects to a graphics processor 1550 via an Accelerated Graphics Port (AGP). The NB/MCH 1525 also connects to the SB/ICH 1520 via an internal bus (e.g., a unified media interface or a direct media interface). The CPU 1530 may contain one or more processors and even may be implemented using one or more heterogeneous processor systems.

For example, FIG. 16 shows one implementation of the CPU 1530. In one implementation, an instruction register 1638 retrieves instructions from a fast memory 1640. At least part of these instructions is fetched from the instruction register 1638 by a control logic 1636 and interpreted according to the instruction set architecture of the CPU 1530. Part of the instructions can also be directed to a register 1632. In one implementation, the instructions are decoded according to a hardwired method, and in another implementation, the instructions are decoded according to a microprogram that translates instructions into sets of CPU configuration signals that are applied sequentially over multiple clock pulses. After fetching and decoding the instructions, the instructions are executed using an Arithmetic Logic Unit (ALU) 1634 that loads values from the register 1632 and performs logical and mathematical operations on the loaded values according to the instructions. The results from these operations can be feedback into the register 1632 and/or stored in the fast memory 1640. According to certain implementations, the instruction set architecture of the CPU 1530 can use a reduced instruction set architecture, a complex instruction set architecture, a vector processor architecture, and a very large instruction word architecture. Furthermore, the CPU 1530 can be based on a Von Neuman model or a Harvard model. The CPU 1530 can be a digital signal processor, an FPGA, an ASIC, a Programmable Logic Array (PLA), a PLD, or a Complex Programmable Logic Device (CPLD). Further, the CPU 1530 can be an x86 processor by the Intel or by the AMD; an Advanced Reduced Instruction Set Computing (RISC) Machine (ARM) processor, a power architecture processor by, e.g., an International Business Machines Corporation (IBM); a Scalable Processor Architecture (SPARC) processor by Sun Microsystems or by Oracle; or other known CPU architecture.

Referring again to FIG. 15, the data processing system 1500 can include that the SB/ICH 1520 is coupled through a system bus to an I/O Bus, a ROM 1556, a Universal Serial Bus (USB) port 1564, a flash Binary Input/Output System (BIOS) 1568, and a graphics controller 1558. PCI/PCIe devices can also be coupled to SB/ICH 1688 through a PCI bus 1562.

The PCI devices may include, for example, Ethernet adapters, add-in cards, and Personal Computer (PC) cards for notebook computers. The HDD 1560 and an optical drive 1566 (e.g., CD-ROM) can use, for example, an Integrated Drive Electronics (IDE) or a Serial Advanced Technology Attachment (SATA) interface. In one implementation, and I/O bus can include a super I/O (SIO) device.

Further, the HDD 15160 and the optical drive 1566 can also be coupled to the SB/ICH 1520 through a system bus. In one implementation, a keyboard 1570, a mouse 1572, a serial port 1576, and a parallel port 1578 can be connected to the system bus through the I/O bus. Other peripherals and devices that can be connected to the SB/ICH 1520 using a mass storage controller such as the SATA or a Parallel Advanced Technology Attachment (PATA), an Ethernet port, an ISA bus, a Low Pin Count (LPC) bridge, a System Management (SM) bus, a Direct Memory Access (DMA) controller, and an Audio Compressor/Decompressor (Codec).

Moreover, the present disclosure is not limited to the specific circuit elements described herein, nor is the present disclosure limited to the specific sizing and classification of these elements. For example, the skilled artisan will appreciate that the described system and methodologies may be adapted based on the availability of different neuroimaging modalities, the selection of genetic or multi-omics datasets, or the specific clinical requirements associated with distinguishing among dementia subtypes or predicting disease progression.

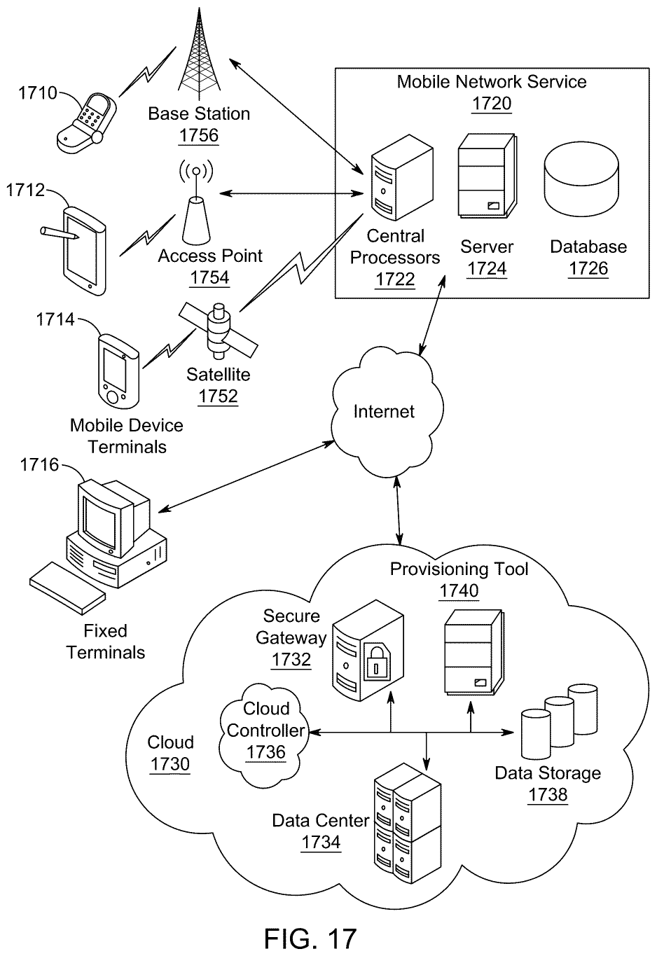

The functions and features described herein may also be executed by various distributed components of a system. For example, one or more processors may execute these system functions, wherein the processors are distributed across multiple components communicating in a network. The distributed components may include one or more client and server machines, which may share processing, as shown by FIG. 17, in addition to various human interface and communication devices (e.g., display monitors, smart phones, tablets, personal digital assistants (PDAs)). More specifically, FIG. 17 illustrates client devices including a smart phone 1711, a tablet 1712, a mobile device terminal 1714 and fixed terminals 1716. These client devices may be commutatively coupled with a mobile network service 1720 via a base station 1756, an access point 1754, a satellite 1752 or via an internet connection. The mobile network service 1720 may comprise central processors 1722, a server 1724 and a database 1726. The fixed terminals 1716 and the mobile network service 1720 may be commutatively coupled via an internet connection to functions in cloud 1730 that may comprise a security gateway 1732, a data center 1734, a cloud controller 1736, a data storage 1738 and a provisioning tool 1740. The network may be a private network, such as the LAN or the WAN, or may be the public network, such as the Internet. Input to the system may be received via direct user input and received remotely either in real-time or as a batch process. Additionally, some implementations may be performed on modules or hardware not identical to those described. Accordingly, other implementations are within the scope that may be disclosed.

The above-described hardware description is a non-limiting example of corresponding structure for performing the functionality described herein.

Numerous modifications and variations of the present disclosure are possible in light of the above teachings. It is therefore to be understood that the invention may be practiced otherwise than as specifically described herein.

1. A computer-implemented method of training a deep neural network for flood susceptibility prediction, the method comprising:
receiving training data comprising flood conditioning factor data for spatial units of a geographic region together with ground truth data representing historical flood occurrences;
inputting the training data into a deep neural network to provide a susceptibility probability;
generating a plurality of candidate solutions, each candidate solution including a parameter vector of weights and biases encoding relationships between the flood conditioning factors and the flood susceptibility outcomes, wherein the generating includes sampling and perturbing the parameter vectors across the solution space;
refining the candidate solutions by (a) applying a local search optimization process that iteratively adjusts the weights and biases of the deep neural network to minimize a cost function computed relative to the ground truth data, thereby generating refined candidate solutions, (b) evaluating the refined candidate solutions using the cost function, and (c) retaining, for subsequent iterations, the refined candidate solutions having improved cost values and the candidate solutions whose refined versions do not yield improved cost values, as retained solutions;
selecting, based on the cost function, a trained set of weights and biases for the deep neural network from among the retained solutions; and
applying the trained set of weights and biases to the deep neural network to generate a trained deep neural network configured to produce flood susceptibility probabilities for input flood conditioning factor data.

2. The method of claim 1 further comprising:
applying the trained deep neural network to flood conditioning factor data of a specified geographic region to generate susceptibility probability values for spatial units of the geographic region;
classifying the susceptibility probability values into a plurality of susceptibility categories; and
generating a geospatial flood susceptibility map of the geographic region with zones corresponding to the susceptibility categories.

3. The method of claim 1, wherein generating the plurality of candidate solutions includes:
perturbing each candidate solution within a neighborhood of its current parameter values to produce an updated candidate solution,
refining the updated candidate solution using the local search optimization process to reduce the cost function, thereby generating a refined candidate solution, and
replacing the candidate solution with the refined candidate solution if the refined candidate solution yields an improved cost value, otherwise incrementing a failure count associated with the candidate solution.

4. The method of claim 1, wherein generating the plurality of candidate solutions further comprises:
computing a selection probability for each candidate solution based on the cost function,
probabilistically selecting candidate solutions according to the selection probabilities,
perturbing each selected candidate solution to produce an updated candidate solution,
refining the updated candidate solution using the local search optimization process to reduce the cost function, thereby generating a refined candidate solution, and
replacing the selected candidate solution with the refined candidate solution if the refined candidate solution yields an improved cost value.

5. The method of claim 1, wherein generating the plurality of candidate solutions further comprises:
identifying a candidate solution having a failure count that exceeds a predefined threshold,
generating a replacement candidate solution for the identified candidate solution,
refining the replacement candidate solution using the local search optimization process to reduce the cost function, thereby producing a refined candidate solution, and
replacing the candidate solution with the refined candidate solution if the refined candidate solution yields an improved cost value.

6. The method of claim 5, wherein generating the replacement candidate solution comprises using a directed update relative to a best-performing candidate solution and an oppositional update relative to an existing candidate solution.

7. The method of claim 1, wherein each candidate solution is associated with an improvement indicator that is incremented when a candidate solution is replaced by a refined candidate solution having an improved cost value, and wherein the improvement indicator is used to guide generation of replacement candidate solutions.

8. The method of claim 1, wherein selecting the trained set of weights and biases includes:
selecting, from among the retained solutions, the candidate solution associated with the lowest value of the cost function.

9. The method of claim 1, wherein refining each retained candidate solution by the local search optimization process includes:
initializing the deep neural network with the retained candidate solution and iteratively updating the weights and biases until the cost function converges below a predetermined threshold or a maximum number of iterations is reached.

10. The method of claim 1, wherein generating the plurality of candidate weight and bias solutions is performed using a Gbest-guided Artificial Bee Colony with directed scout (GABCds) algorithm, and wherein refining the retained candidate solutions is performed using a Levenberg-Marquardt algorithm.

11. A system for training a deep neural network for flood susceptibility prediction, the system comprising:
at least one processor; and
a memory storing instructions that, when executed by the processor, cause the system to:
receive training data comprising flood conditioning factor data for spatial units of a geographic region together with ground truth data representing historical flood occurrences;
input the training data into a deep neural network to provide a susceptibility probability;
generate a plurality of candidate solutions, each candidate solution including a vector of weights and biases encoding relationships between the flood conditioning factors and the flood susceptibility outcomes, wherein the generating includes sampling and perturbing the vectors across the solution space;
refine the candidate solutions by (a) applying a local search optimization process that iteratively adjusts the weights and biases of the deep neural network to minimize a cost function computed relative to the ground truth data, thereby producing a plurality of refined solutions, (b) evaluating the refined solutions using the cost function, and (c) retaining, for subsequent iterations, the refined solutions having improved cost values and the candidate solutions whose refined versions do not yield improved cost values, as retained solutions; and
select, based on the cost function, a trained set of weights and biases for the deep neural network from among the retained solutions.

12. The system of claim 11, wherein the instructions, that when executed by the processor, further cause the system to:
apply the trained set of weights and biases to the deep neural network to generate a trained deep neural network configured to produce flood susceptibility probabilities for input flood conditioning factor data.

13. The system of claim 11, wherein the instructions, that when executed by the processor, further cause the system to:
apply the trained deep neural network to flood conditioning factor data of a specified geographic region to generate a geospatial flood susceptibility map of the geographic region.

14. The system of claim 11, wherein the instructions for generating the plurality of candidate solutions, that when executed by the processor, cause the system to:
perturb each candidate solution within a neighborhood of its current parameter values to produce an updated candidate solution,
refine the updated candidate solution by applying the local search optimization process to reduce the cost function, thereby generating a refined solution, and
replace the candidate solution with the refined solution if the refined solution yields an improved cost value, otherwise retain the candidate solution and increment a failure count associated with the candidate solution.

15. The system of claim 11, wherein the instructions for generating the plurality of candidate solutions, that when executed by the processor, cause the system to:
compute a selection probability for each candidate solution based on the cost function,
probabilistically select candidate solutions according to the selection probabilities,
perturb each selected candidate solution to produce an updated candidate solution,
refine the updated candidate solution by applying the local search optimization process to reduce the cost function, thereby generating a refined solution, and
replace the selected candidate solution with the refined solution if the refined solution yields an improved cost value.

16. The system of claim 11, wherein the instructions for generating the plurality of candidate solutions, that when executed by the processor, cause the system to:
identify a candidate solution having a failure count that exceeds a predefined threshold,
generate a replacement candidate solution for the identified candidate solution,
refine the replacement candidate solution by applying the local search optimization process to reduce the cost function, thereby producing a refined solution, and
replace the candidate solution with the refined solution if the refined solution yields an improved cost value.

17. The system of claim 16, wherein the instructions for generating the replacement candidate solution, that when executed by the processor, cause the system to:
select at least one of a directed update relative to a best-performing candidate solution and an oppositional update relative to an existing candidate solution.

18. A non-transitory computer-readable medium storing instructions that, when executed by at least one processor, cause a system to perform a method comprising:
receiving training data comprising flood conditioning factor data for spatial units of a geographic region together with ground truth data representing historical flood occurrences;
inputting the training data into a deep neural network to provide a susceptibility probability;
generating a plurality of candidate solutions, each candidate solution including a vector of weights and biases encoding relationships between the flood conditioning factors and the flood susceptibility outcomes, wherein the generating includes sampling and perturbing the vectors across the solution space;
refining the candidate solutions by (a) applying a local search optimization process that iteratively adjusts the weights and biases of the deep neural network to minimize a cost function computed relative to the ground truth data, thereby producing a plurality of refined solutions, (b) evaluating the refined solutions using the cost function, and (c) retaining, for subsequent iterations, the refined solutions having improved cost values and the candidate solutions whose refined versions do not yield improved cost values, as retained solutions; and
selecting, based on the cost function, a trained set of weights and biases for the deep neural network from among the retained solutions.

19. The non-transitory computer-readable medium of claim 18, wherein generating the plurality of candidate solutions includes:
perturbing each candidate solution within a neighborhood of its current parameter values to produce an updated candidate solution,
refining the updated candidate solution by applying the local search optimization process to reduce the cost function, thereby generating a refined solution, and
replacing the candidate solution with the refined solution if the refined solution yields an improved cost value.

20. The non-transitory computer-readable medium of claim 18, wherein generating the plurality of candidate solutions is performed using a Gbest-guided Artificial Bee Colony with directed scout (GABCds) algorithm, and wherein refining the retained candidate solutions is performed using a Levenberg-Marquardt algorithm.
